(19) United States
(12) Patent Application Publication
(10) Pub. No.: US 2010/0072309 A1
(43) Pub. Date: Mar. 25, 2010

(54) ELECTROSTATIC PAINT SPRAYING DEVICE

(75) Inventors: Jeremy David Hodge, Berkshire (GB); John Ord, Cambridge (GB); Mike Cane, Cambridge (GB); Mike Beadman, Herts (GB); Andrew White, Cambridgeshire (GB); Nick Field, Cambridgeshire (GB)

Correspondence Address: KENYON & KENYON LLP, ONE BROADWAY, NEW YORK, NY, 10004, US

(73) Assignee: AKZO NOBEL COATINGS INTERNATIONAL B.V., ARNHEM (NL)

(21) Appl. No.: 12/520,050

(22) PCT Filed: Dec. 18, 2007
(86) PCT No.: PCT/EP2007/011092

§ 371 Date: Aug. 31, 2009

(30) Foreign Application Priority Data
Dec. 18, 2006 (GB) 0625127.6
Sep. 14, 2007 (GB) 0717939.3
Sep. 14, 2007 (GB) 0717940.1
Sep. 14, 2007 (GB) 0717941.9
Sep. 14, 2007 (GB) 0717942.7
Sep. 14, 2007 (GB) 0717943.5
Sep. 14, 2007 (GB) 0717944.3
Sep. 14, 2007 (GB) 0717945.0
Sep. 14, 2007 (GB) 0717946.8
Sep. 14, 2007 (GB) 0717947.6

(51) Int. Cl. B05B 5/00; B05B 9/03; B65D 25/40

(52) U.S. Cl. 239/690; 239/302; 222/566

(57) ABSTRACT

An electrostatic paint spraying device (10) comprising a paint canister (16) fluidly connected to a nozzle of the paint spraying device, in which the nozzle comprises a spray head (50) having a plurality of channels from which paint is propelled.

The present invention relates to an electrostatic paint spraying device, a nozzle for use in an electrostatic spraying device, a paint canister for use in an electrostatic paint spraying device, and a method of electrostatically spraying a target with paint.

Electrostatic paint spraying devices are known whereby paint is electrostatically charged and delivered to a nozzle under pressure, whereupon it is atomised under the influence of an electrostatic field, and propelled towards a target surface.

One of the advantages of electrostatic spraying is the fact that the paint is attracted to the target surface, and will also wrap-around the back of a target, this being particularly useful when spraying a target such as metal railings.

EP0186983 describes the technology upon which the electrostatic spraying of the present invention is based.

Known electrostatic paint spraying devices utilise a nozzle having a single channel through which the paint flows before being propelled towards the target surface.

The problem with known electrostatic paint spraying devices is the insufficient volume of paint that is propelled towards the target surface to enable effective painting. Whilst the flow rate can be increased to deliver more paint, this causes problems in that the paint will not be sufficiently atomised. Increasing the flow rate to deliver more paint can also result in paint not settling on the target surface, or wrapping behind a target surface.

According to the present invention there is provided an electrostatic paint spraying device comprising a paint reservoir fluidly connected to a nozzle of the paint spraying device, in which the nozzle comprises a plurality of channels from which paint is propelled.

Advantageously, increasing the number of channels enables the flow rate from each channel to be kept sufficiently low to enable atomisation, but still provide a greater volume of paint to be delivered to the target surface.

According to another aspect of the present invention there is provided a method of electrostatically spraying a target with paint, comprising the steps of providing an electrostatic spray device having a pressurised paint canister which supplies paint to a nozzle comprising a plurality of channels, a charging electrode to charge the paint, and a field adjusting electrode to generate a potential difference relative to the charging electrode, the paint having a conductivity between 75 to 450 nano-Siemens per metre (nSm⁻¹), the paint being delivered to the channels at a flow rate of between 12 and 30 ml/s such that the paint is atomised and propelled towards the target so as to form a coating on the target.

Preferably the charging electrode is set at a voltage between 27 kV and 33 kV, and the field adjusting electrode is set at a voltage between 3 kV and 7 kV.

Preferably the paint has a viscosity of between 1.5 and 3.5 Poise, preferably between 2 and 3 Poise.

Advantageously, the applicant has discovered a set of paint properties and spraying conditions which enable the paint to be successfully sprayed onto a target surface.

Known electrostatic paint spraying devices utilise a remote paint reservoir which is fed to the spraying device using a tube. Such devices are limited by their lack of portability and complexity. Such devices are typically used by skilled users, and not appropriate for use by amateur decorators.

A further problem which such devices is the need to clean the tubing and reservoir between jobs, or if an alternative paint colour or type is required.

According to another aspect of the present invention there is provided an electrostatic paint spraying device comprising a releasably attachable paint canister which feeds paint to a nozzle of the paint spraying device.

Advantageously this eliminates the need to have a remote supply of paint and therefore increases the portability of the paint spraying device.

Furthermore, no additional paint tubing is required to feed paint to the spraying device from a remote paint reservoir. The fact that the paint canister can be removed from the paint spraying device enables it to be thrown away after use, thereby eliminating the need for cleaning, and reducing possible cross-contamination when paint of different properties and colour is used.

Preferably the paint canister is pre-pressurised.

Advantageously this provides a supply of paint to the nozzle under pressure without the need for manual or powered pressure generation.

Furthermore, by using a pre-pressurised canister, it is possible to use the paint spraying device through an angle of 360 degrees without the concerns of non pre-pressurised paint canisters.

Preferably the nozzle is integrated with the paint canister.

Advantageously this enables the paint to flow from the canister and onto the target via the nozzle without coming into contact with other parts of the paint spraying device, thereby eliminating the need to clean any other parts of the spraying device.

Preferably the nozzle includes an integrated charging electrode. If the integrated nozzle and container are disposable, the charging electrode is also disposable, which is advantageous since the charging electrode comes into contact with paint.

Preferably the pre-pressurised paint canister comprises an outer container and a collapsible inner bag located within the outer container, in which the outer container contains a propellant which acts upon the inner bag to permit paint to flow from the inner bag via a release valve positioned on the inner bag.

Advantageously, the propellant is not mixed with the paint inside the bag, in contrast to an aerosol based system, and therefore there are no chemical compatibility issues between paint and propellant.

Another problem associated with aerosols is the fact it is difficult to control the spray pattern as the propellant expands as it is released via the paint release valve.

Known nozzles for electrostatic paint spraying devices are manufactured from metal, and typically require a significant amount of complex machining to create a paint path between the paint supply and the nozzle exit. This adds to the time and cost to produce the nozzle which is a considerable problem in the case of high volume manufacture.

According to another aspect of the present invention there is provided a nozzle for an electrostatic paint spray device, the nozzle comprising a first moulded clam shell and a second moulded clam shell, the first and second moulded clam shells being arranged such that once assembled together, a chamber and a plurality of channels are formed between the clam shells, the chamber and plurality of channels defining part of a paint path from a paint supply.

Advantageously, forming the nozzle from two shells enables a complex paint path to be created using a moulding process, such as injection moulding, and eliminates, or at least greatly reduces the need for additional machining of the nozzle.

It is possible to provide a paint canister having an integrated nozzle. The paint canister contains paint held under pressure which is prevented from release by a pressure release valve. When the paint canister is connected to the spraying device, actuation of the canister via a trigger causes the pressure release valve to open, and enables paint to flow such that it can be sprayed onto the target surface.

One problem with devices having removable paint canisters is preventing paint flow until the paint canister is correctly connected to the spraying device. It is possible to prevent access to the pressure release valve by using an overcap, however this adds to the cost of the canister, and furthermore, offers no prevention if inadvertently removed.

According to another aspect of the present invention there is provided an electrostatic paint spraying device comprising a paint canister, the paint canister including a release valve to control release of paint from the canister, in which the paint canister includes a locking feature which cooperates with a corresponding unlocking feature on the paint spraying device such that the release valve cannot release paint until the locking and unlocking features engage.

According to another aspect of the present invention there is provided a paint canister for an electrostatic paint spraying device, the paint canister including a release valve to control release of paint from the canister, in which the paint canister includes a locking feature which cooperates with a corresponding unlocking feature on the paint spraying device such that the release valve cannot release paint until the locking and unlocking features engage.

Advantageously this prevents paint flow until the paint canister has been correctly housed within the paint spraying device.

Preferably cooperation between the locking feature on the paint canister and unlocking features on the spraying device is by engagement, and therefore the user will physically detect when the canister has been correctly housed within the spraying device.

Preferably the locking feature is provided on a nozzle of the paint canister such that nozzle has a secondary use of preventing paint from being sprayed until the canister is housed within the spraying device.

A problem with known electrostatic paint spraying devices relates to the fact that a user must manipulate the nozzle to connect it to the spraying device.

According to another aspect of the present invention there is provided an electrostatic paint spraying device having a casing and a paint canister, the paint canister having an integrated nozzle at one free end, and a second free end remote from the nozzle, in which the paint canister can be inserted into the casing by a user without touching the nozzle.

Advantageously the user does not have to come into contact with the nozzle which can be both charged and/or have traces of paint present.

It is important that a user cannot come into contact with charged parts of the spraying device.

According to another aspect of the present invention there is provided an electrostatic paint spraying device including a casing for receiving a paint canister, a releasably attachable cover to enclose the paint canister when housed in the casing, and a power supply, in which casing includes a first feature that cooperates with a corresponding second feature on the cover such that the power supply is disabled unless the first and second features cooperate when the cover is positioned on the casing.

Advantageously this prevents the paint canister from being charged until the cover is positioned on the casing, at which point, the paint canister is enclosed by the cover.

Preferably the first feature is a first and second independently operable switch moveable between open and closed positions, the power supply being disabled until both switches are in the closed position. The use of two switches eliminates the likelihood of the power being enabled if one switch is inadvertently closed.

Preferably the first feature is provided in a recess of the casing so as to restrict access. More preferably the recess includes an overhang to further restrict access such that only the second feature of the cover can enter the recess. This is advantageous as it reduces the likelihood of finger access, and/or inserting an object to enable the power.

It is important that paint in the vicinity of the nozzle and is charged, otherwise it will not be propelled towards the target surface. Uncharged paint will tend to drip which is undesirable.

According to another aspect of the present invention there is provided an electrostatic paint spraying device comprising a paint canister, a nozzle from which paint is propelled towards a target surface, a charging electrode to charge the paint, a field adjusting electrode to accelerate the paint towards a target, and a power supply connected to the charging and field adjusting electrodes, the paint canister including a paint release valve, in which the charging and field adjusting electrodes are charged when the paint release valve is open.

Advantageously this means no paint is released from the valve unless the electrodes are charged, and the risk of paint dripping is minimised.

According to another aspect of the present invention there is provided an electrostatic paint spraying device having a handle portion and a nozzle outlet from which paint is propelled towards a target, the nozzle outlet being positioned relative to the handle portion such that, when paint is being propelled horizontally from the nozzle, the lowest point of the nozzle is at, or is vertically below the lowest point of the handle portion.

Advantageously this means that a user can spray items close to the ground without the handle fouling the ground which is particularly beneficial when spraying railings or radiators which sit close to the ground.

Preferably the lowest point of the nozzle is at, or is vertically below the lowest point of the spraying device allowing the user to spray items close to the ground, without being concerned about another part of the spraying device coming into contact with the ground.

The paint canister is charged as a result of the electrodes charging the paint, and therefore there is a risk that the paint canister can discharge to a user.

According to another aspect of the present invention there is provided an electrostatic paint spraying device comprising a plastic casing, a plastic inner shell that locates within the plastic casing, and a paint canister having a main body and a nozzle, the paint canister being releasably attachable to the paint spraying device, in which the main body of the paint canister is housed within the plastic inner shell so as to protect a user from electrostatic discharge from the paint canister when the inner shell is housed in the casing.

Providing two layers of material between the paint canister and the user reduces the risk of electrostatic discharge to the user.

Preferably the plastic inner shell and the paint canister form an integral subassembly and the subassembly is releasably attachable to the plastic casing.

Advantageously this ensures that the paint canister is housed within the inner shell at all times, thereby eliminating contact between the user and the paint canister. This is important if the canister is still holding some charge when it is removed from the casing.

Preferably the plastic inner shell is integral with the plastic casing. This is advantageous if the paint canister is a disposable item since it prevents disposing of the inner shell when the canister is disposed of The inner shell does not come into contact with paint, and therefore it is not necessary to dispose of it,

Preferably the plastic casing includes a first portion and a second portion, the first and second portions combining to form the casing, a casing join being created between mating surfaces of the first and second portions, the inner plastic shell includes a first section and a second section, a shell join being created between mating surfaces of the first and second sections, in which the inner shell is arranged within the casing such that the joins are angularly misaligned.

Misaligning the joins creates a longer discharge path compared to if the joins were aligned. Preferably the angular spacing between the casing join and the inner shall join is maximised thereby minimising the chance of discharge from the paint canister between the two joins. In the case where the casing is formed from two halves, and the inner shell is formed from two halves, the inner shell is arranged within the casing such that the maximum angular spacing is 90 degrees.

According to another aspect of the present invention there is provided an electrostatic paint spraying device including a paint canister receiving portion, a handle portion, and a nozzle outlet from which paint is propelled towards a target, in which the paint canister receiving portion is arranged such that when an associated paint canister is housed within the paint spraying device, and paint is being propelled from the nozzle substantially horizontally, the paint canister is inclined at an angle greater than zero and less than 90 degrees relative to the horizontal.

Advantageously this means the spraying device can be more compact compared to known spraying devices where the canister is positioned perpendicularly to the handle portion. This means that larger canisters can be used whilst still maintaining a compact spraying device. Furthermore, the weight distribution is also improved with the canister positioned at an angle above the handle portion.

According to another aspect of the present invention there is provided an electrostatic paint spraying device comprising an enclosure housing for receiving a battery pack, the battery pack comprising a battery compartment for receiving at least one primary cell battery, in which the battery compartment includes a metallic heat sink which substantially surrounds the at least one primary cell battery.

Advantageously, the heat sink allows heat generated by the primary cell battery to dissipate, thereby reducing the risk of an explosion inside the battery compartment.

According to another aspect of the present invention there is provided an electrostatic paint spraying device comprising an enclosure housing for receiving a battery pack, the battery pack comprising a main body and a closure which is releasably attachable to the main body, in which the battery pack locates inside the enclosure housing such that the closure is retained on the main body by engagement with part of the enclosure housing.

Advantageously the fact that the closure is retained on the main body when the battery pack is located inside the enclosure housing reduces the likelihood of explosive gases escaping from the battery pack in the event of an explosion inside the battery pack.

According to another aspect of the present invention. there is provided an electrostatic paint spraying device comprising an enclosure housing for receiving a battery pack, the battery pack comprising a main body and a closure which is releasably attachable to the main body to create a battery compartment for receiving at least one primary cell battery, in which a join is created between the closure and the main body when the closure is attached to the main body, the closure including an inner projection which extends beyond the join into the main body and radially surrounds the at least one primary cell battery.

The invention will now be described, by way of example only, with reference to the accompanying drawings in which:

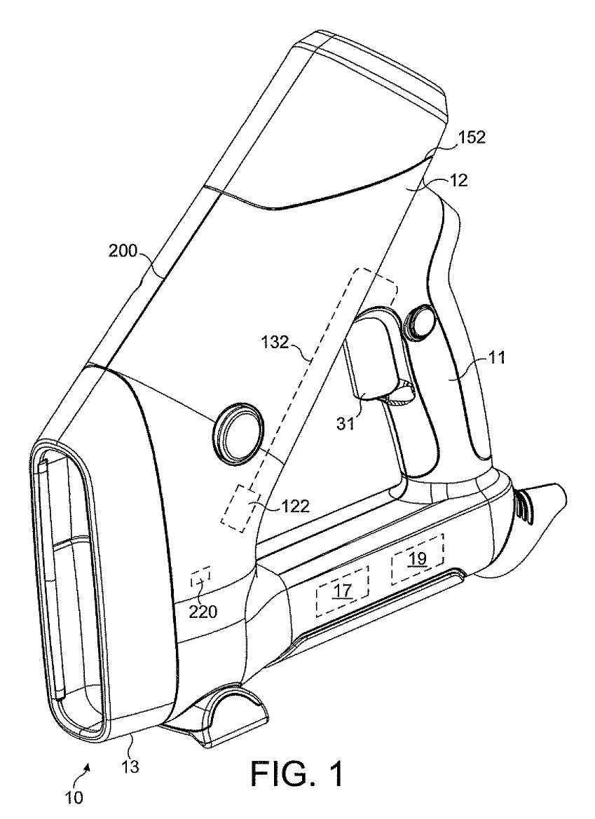

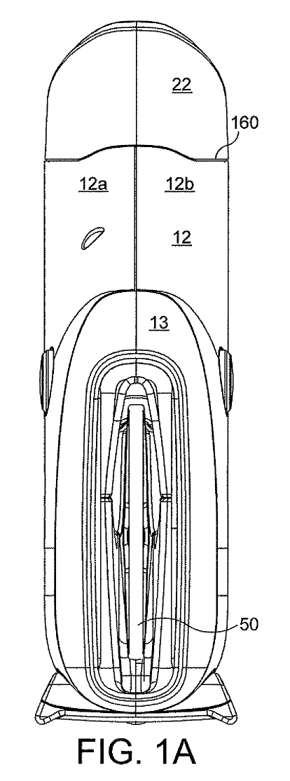

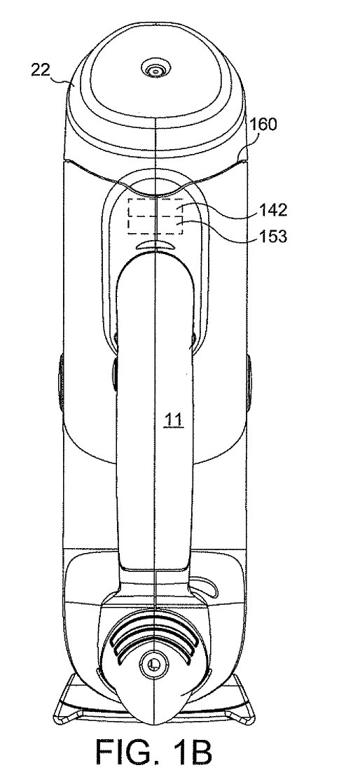

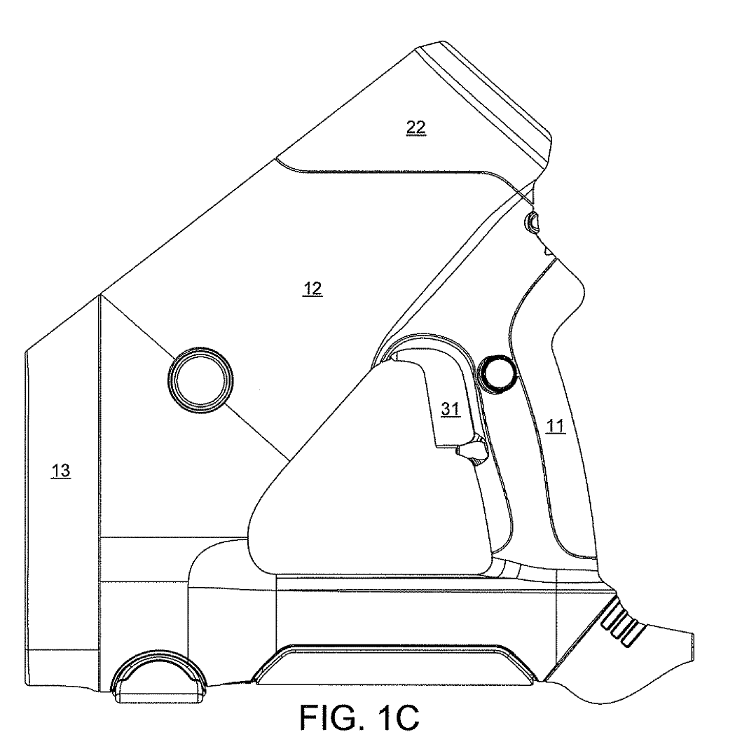

FIG. 1 is an perspective view of an electrostatic paint spraying device according to the present invention,

FIGS. 1A and 1B are front views of the electrostatic paint spraying device of FIG. 1,

FIG. 1C is a side view of the electrostatic paint spraying device of FIG. 1,

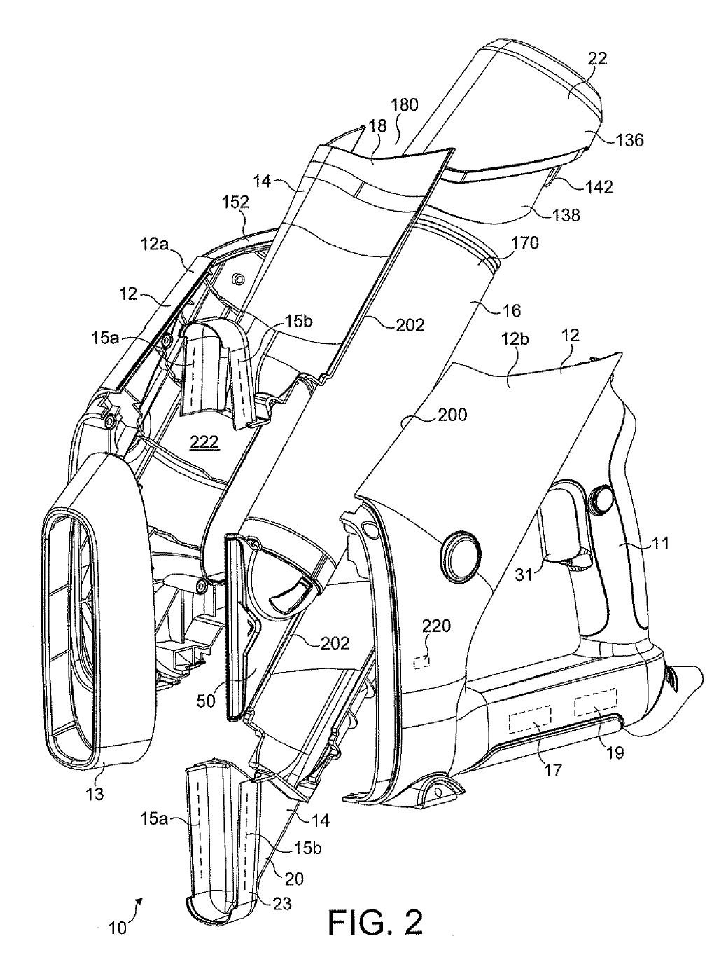

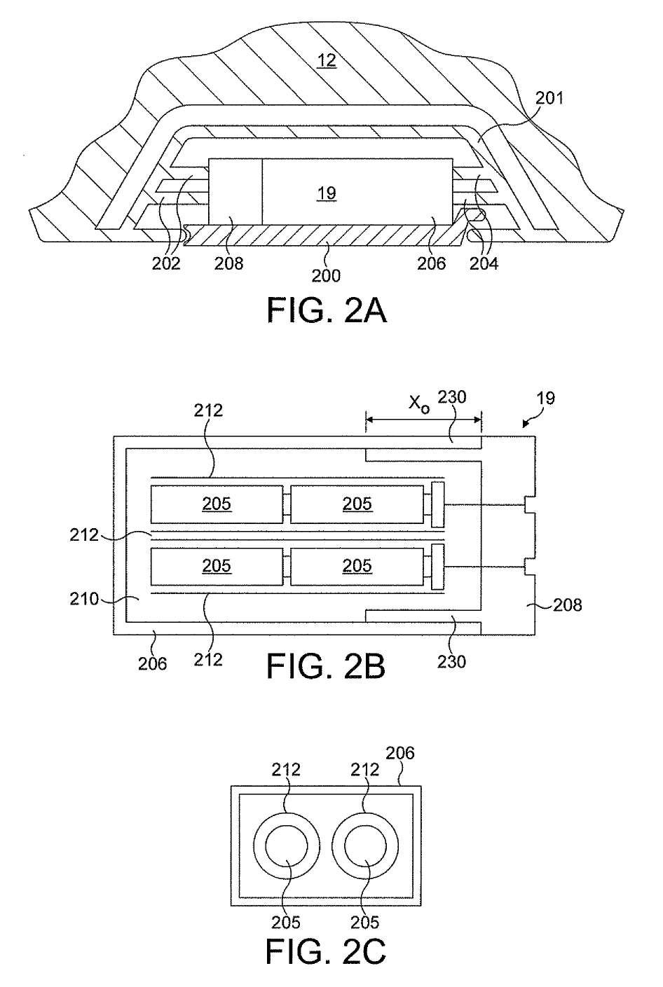

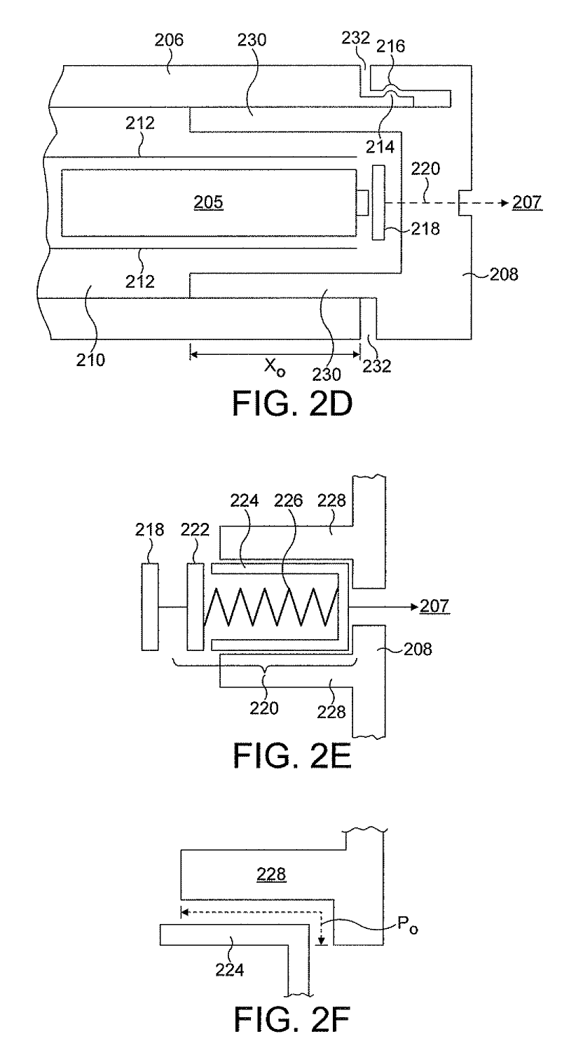

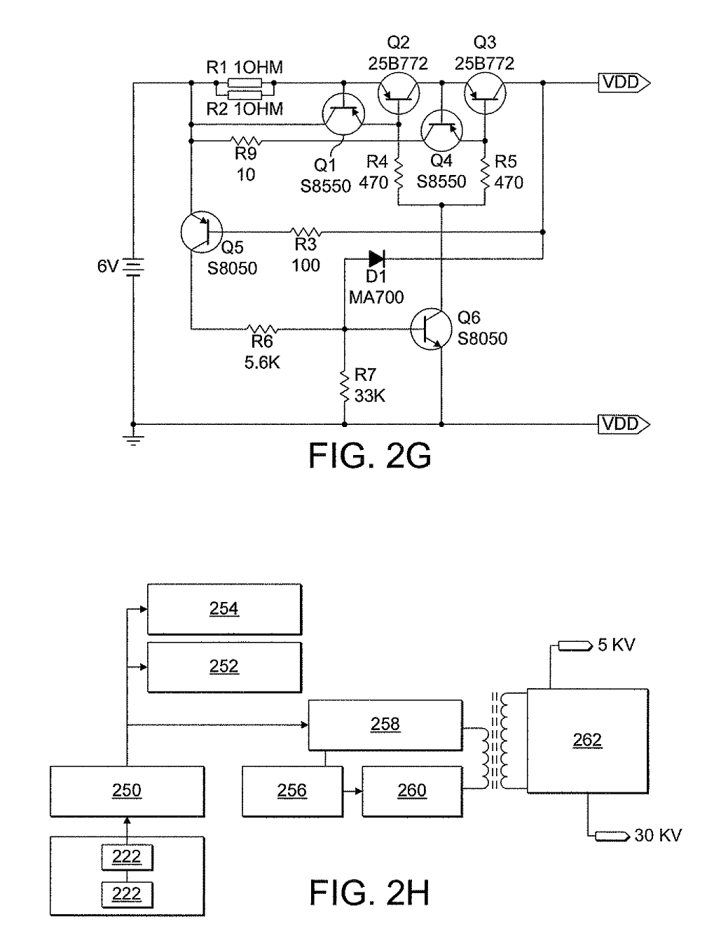

FIG. 2 is an exploded view of the electrostatic paint spraying device of FIG. 1,

FIG. 2A is an enlarged sectional view of part of the paint spraying device of FIG. 1,

FIG. 2B is a plan view of the battery pack of the paint spraying device of FIG. 1,

FIG. 2C is an end view of the battery pack of the paint spraying device of FIG. 1,

FIG. 2D is a front view of part of the battery pack of the paint spraying device of FIG. 1,

FIGS. 2E and 2F are front views of part of the battery pack of the paint spraying device of FIG. 1,

FIG. 2G is a circuit diagram of the current limiting circuit of the paint spraying device of FIG. 1,

FIG. 2H is a block electrical diagram of the paint spraying device of FIG. 1,

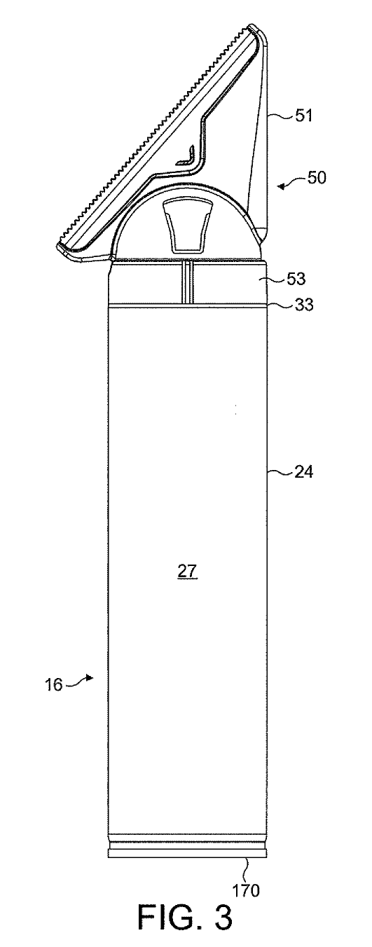

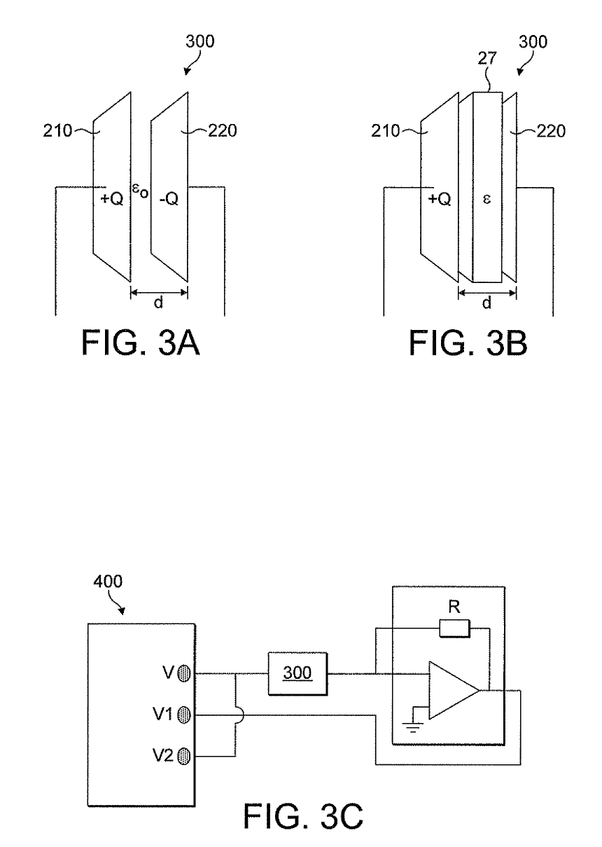

FIG. 3 is a side view of a paint canister according to another aspect of the present invention for use in the electrostatic paint spraying device of FIG. 1,

FIGS. 3A to 3C are schematic diagrams of apparatus to measure the electrical properties of paint for use in the electrostatic paint spraying device of FIG. 1,

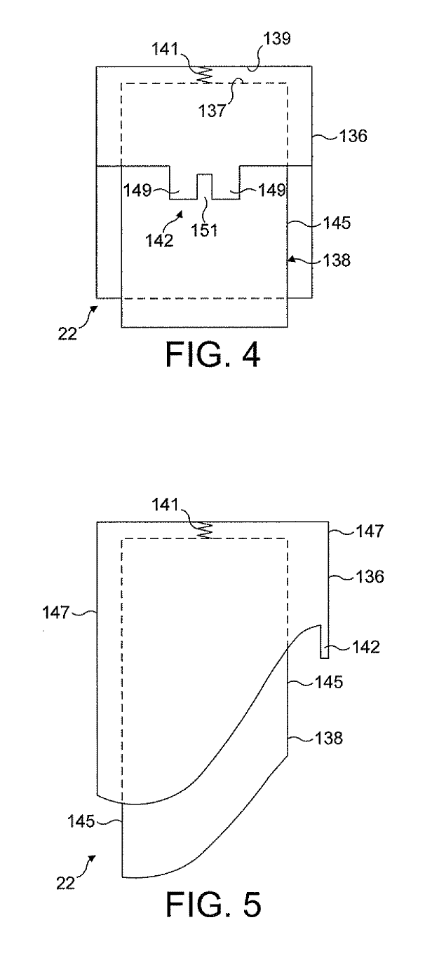

FIG. 4 is a front view of a cover of the electrostatic paint spraying device of FIG. 1,

FIG. 5 is a side view of a cover of the electrostatic paint spraying device of FIG. 1,

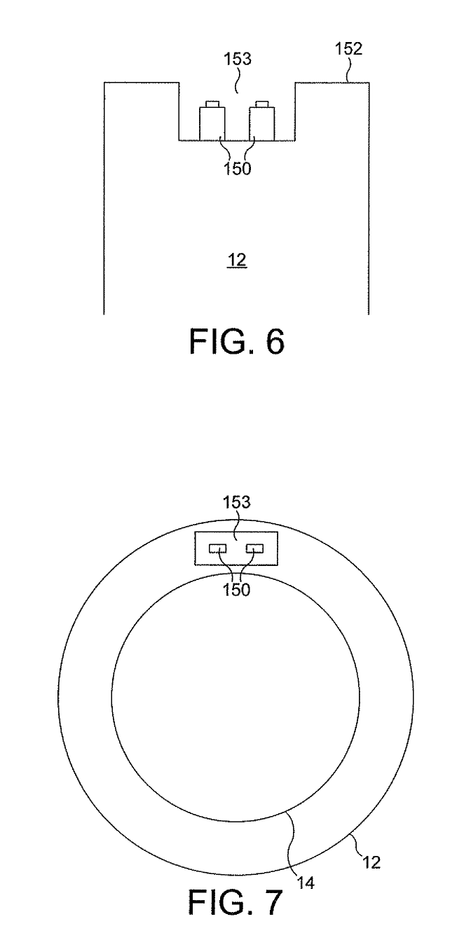

FIG. 6 is a front view showing part of the casing of the electrostatic paint spraying device of FIG. 1,

FIG. 7 is a plan view of the part of the casing shown in FIG. 6,

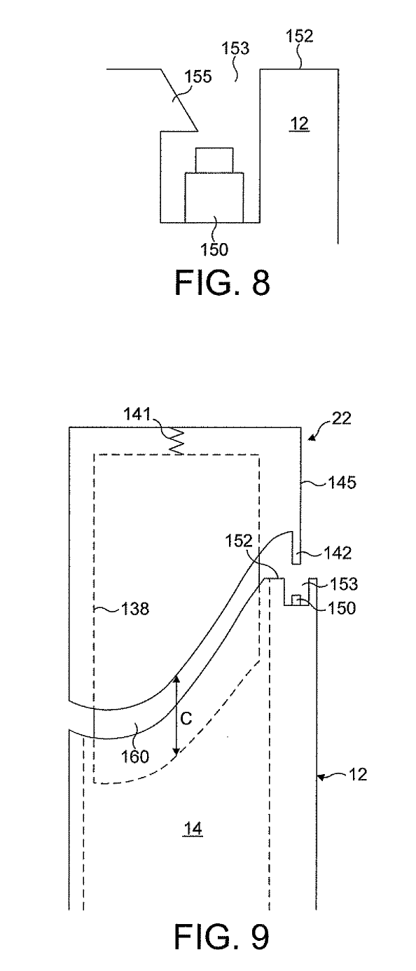

FIG. 8 is an enlarged sectional side view of the part of the casing shown in FIG. 6,

FIG. 9 is a side view of the cover of FIG. 5 assembled onto the casing of the electrostatic paint spraying device of FIG. 1,

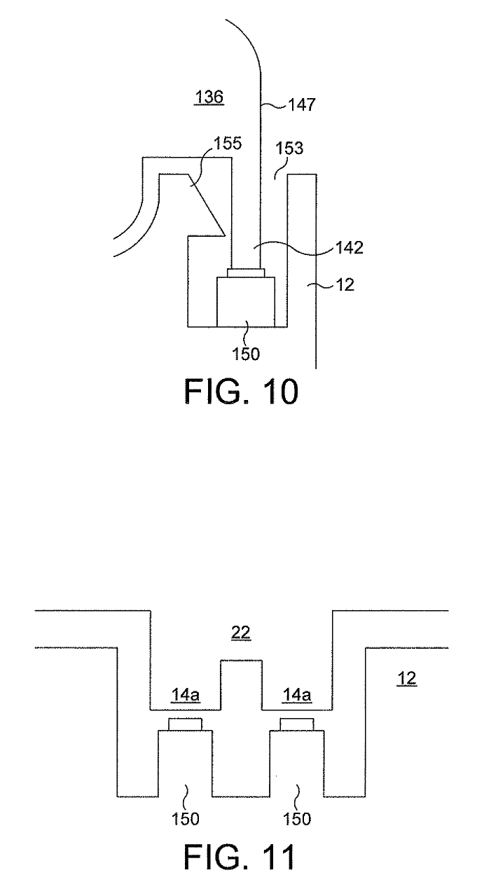

FIG. 10 is an enlarged sectional side view of the assembly of FIG. 9,

FIG. 11 is an enlarged sectional front view of the assembly of FIG. 9,

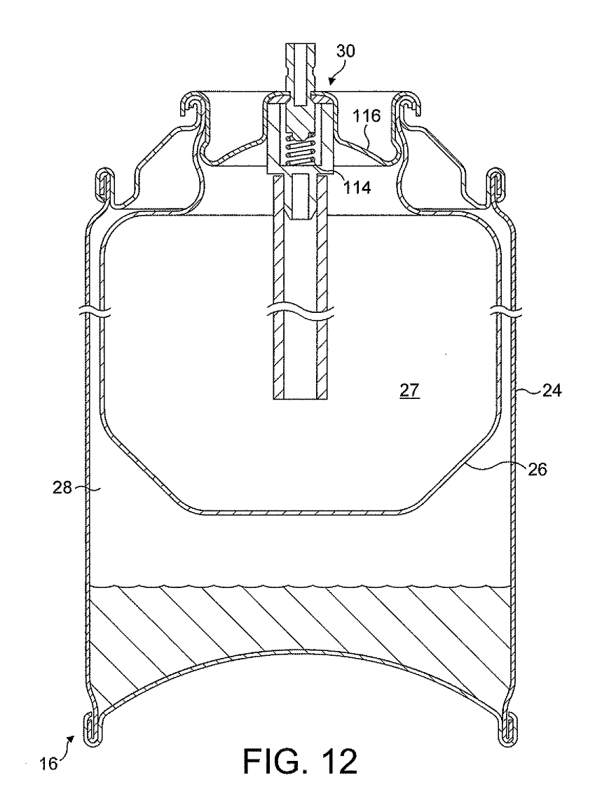

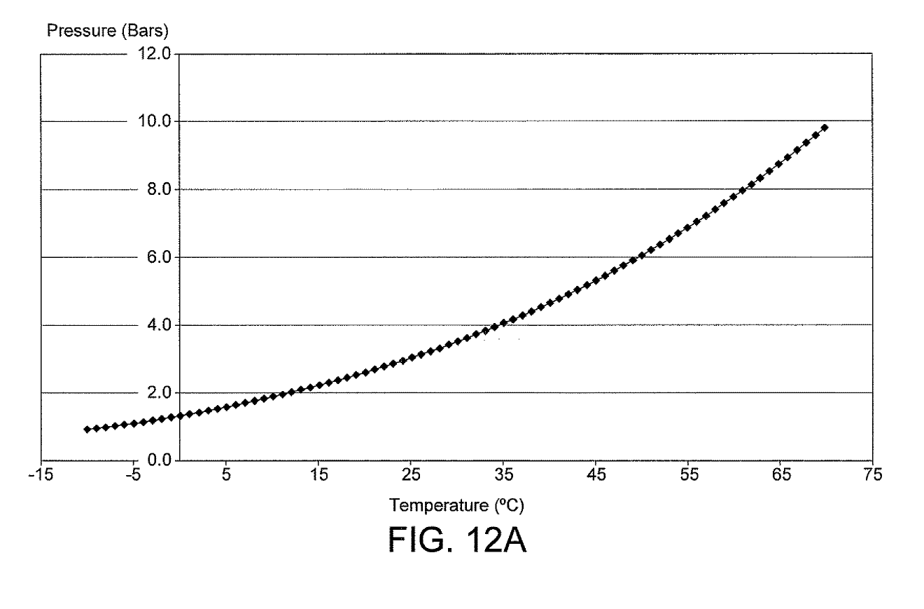

FIG. 12 is a sectional front view of part of the paint canister of FIG. 3,

FIG. 12A is a graph showing varying of vapour pressure with temperature for propellant inside the paint canister of FIG. 3,

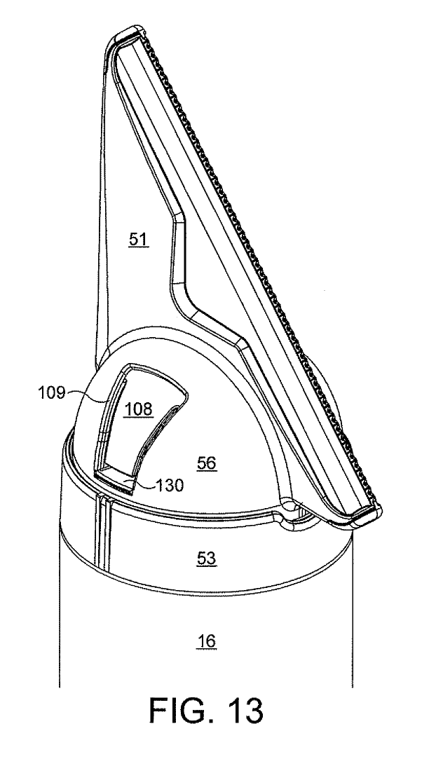

FIG. 13 is a perspective view of part of the paint canister of FIG. 3 including a nozzle according to the present invention,

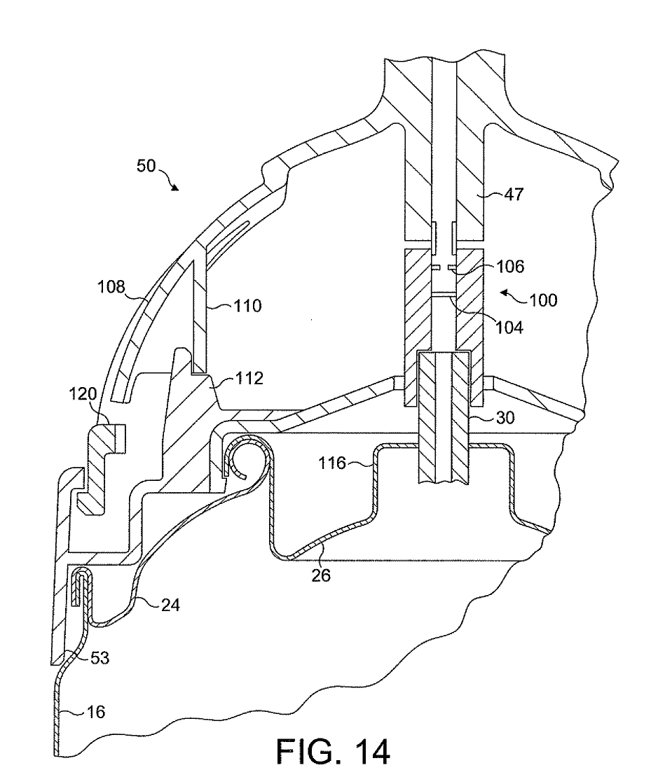

FIG. 14 is a sectional front view of the arrangement of FIG. 13,

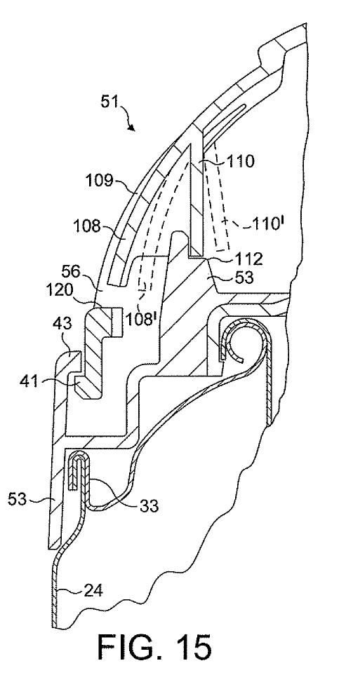

FIG. 15 is an enlarged sectional front view of the arrangement of FIG. 13,

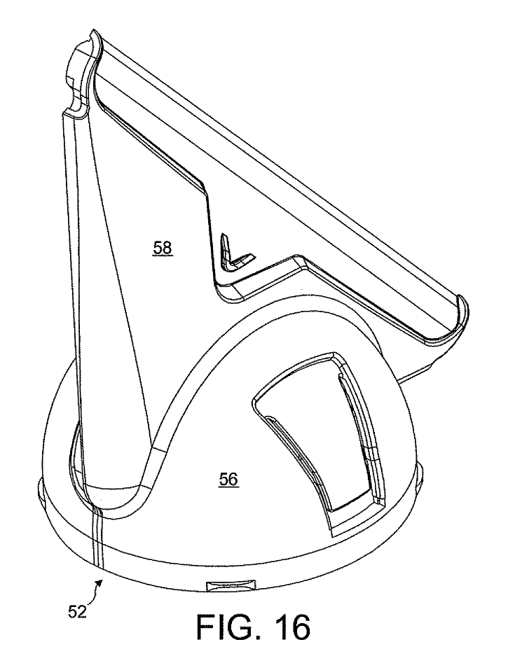

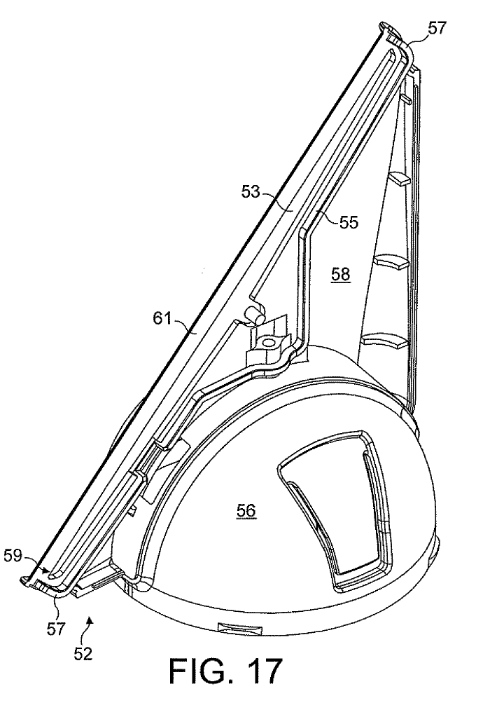

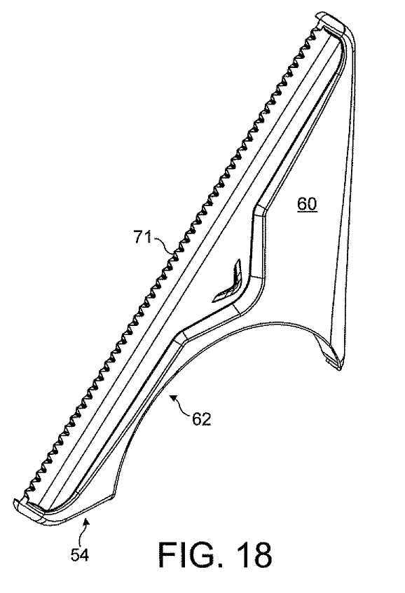

FIGS. 16 to 19 are perspective views of part of the nozzle of FIG. 13,

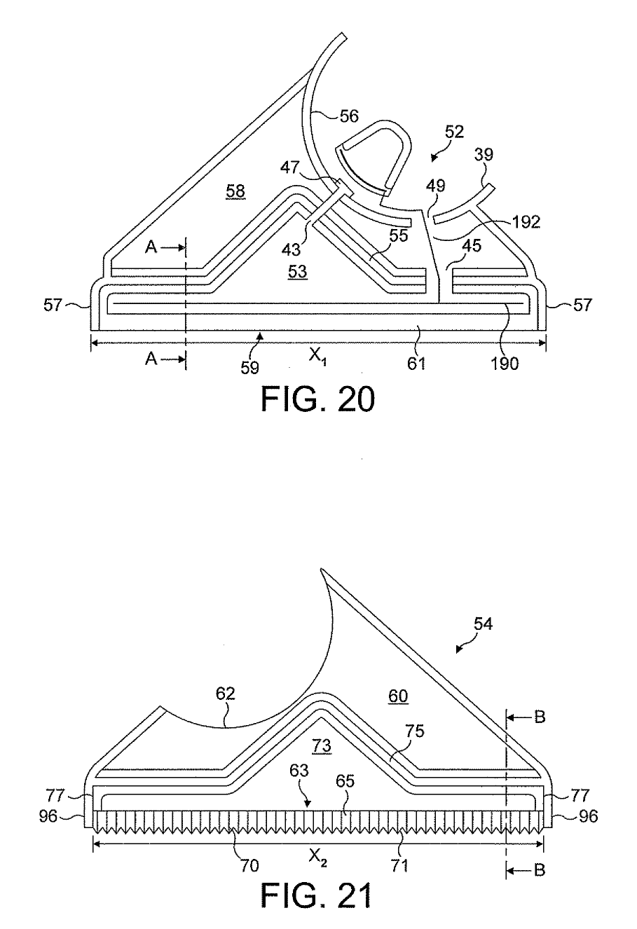

FIGS. 20 and 21 are plan views of part of the nozzle of FIG. 13,

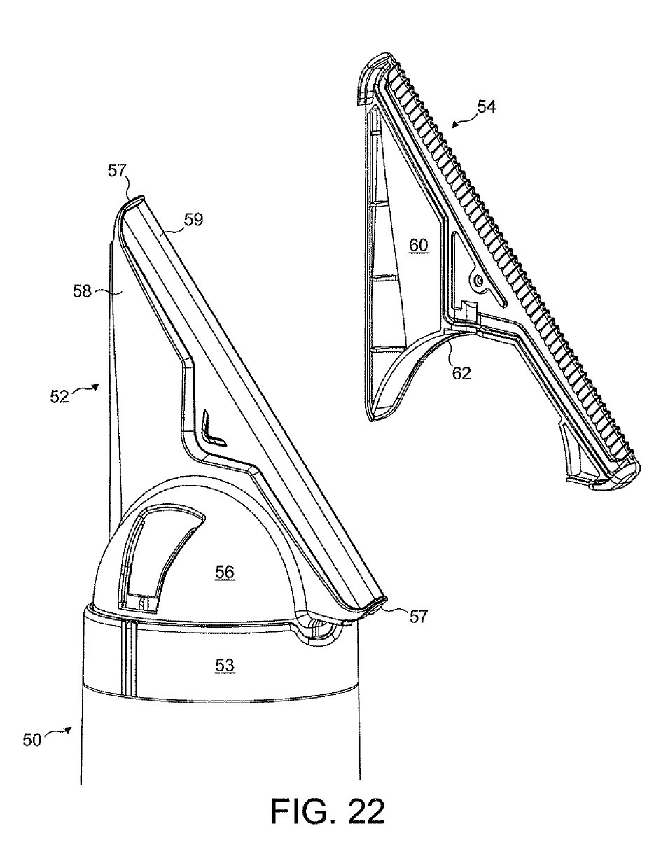

FIG. 22 is an exploded perspective view of part of the paint canister of FIG. 3 including the nozzle of FIG. 13,

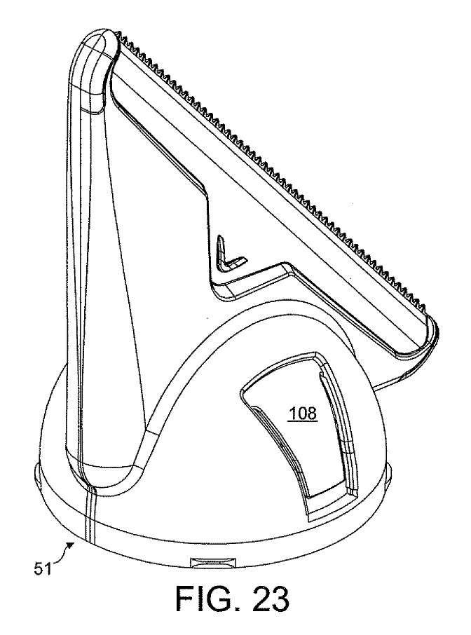

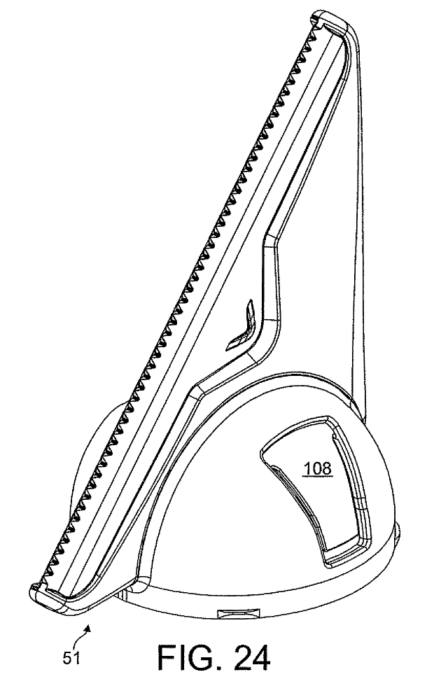

FIGS. 23 and 24 are perspective views of part of the nozzle of FIG. 13,

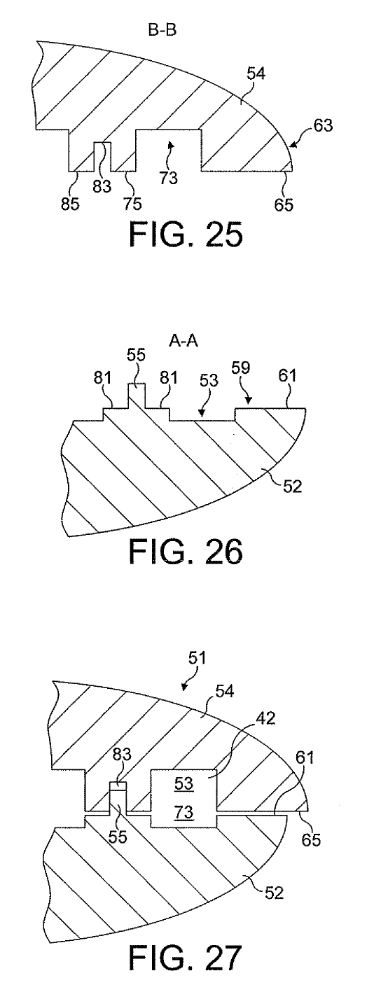

FIGS. 25 to 27 are side sectional views showing part of the nozzle of FIG. 13,

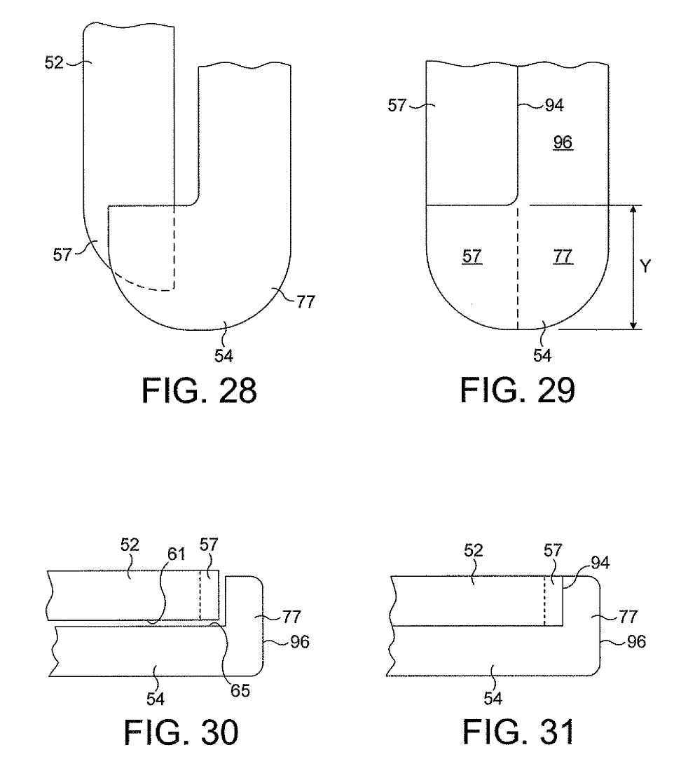

FIGS. 28 and 29 are side views showing part of the nozzle of FIG. 13,

FIGS. 30 and 31 are front views showing part of the nozzle of FIG. 13,

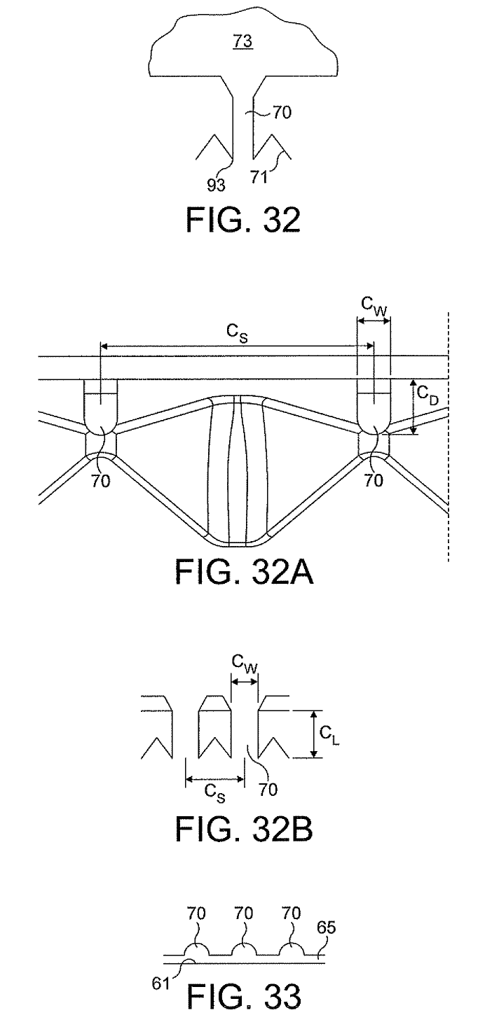

FIG. 32 is a plan view showing part of the nozzle of FIG. 13,

FIG. 32A is a front view showing part of the nozzle of FIG. 13,

FIG. 32B is a plan view showing part of the nozzle of FIG. 13,

FIG. 33 is a front view showing part of the nozzle of FIG. 13,

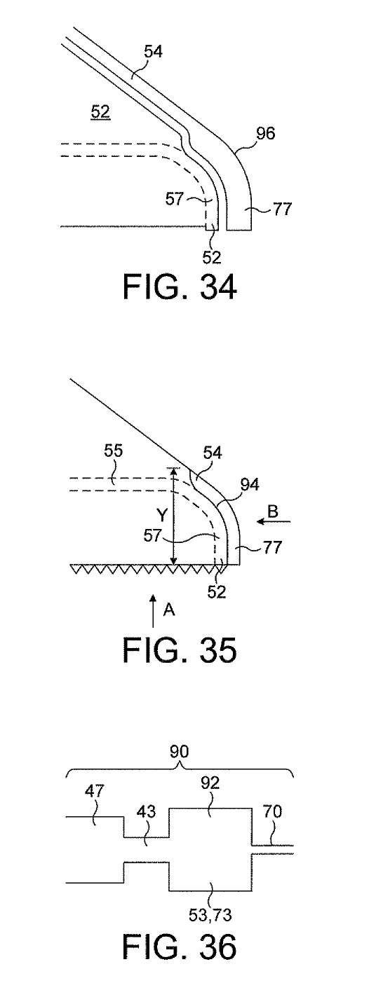

FIGS. 34 and 35 are plan views showing part of the nozzle of FIG. 13,

FIG. 36 is a schematic view showing the paint path in the nozzle of FIG. 13,

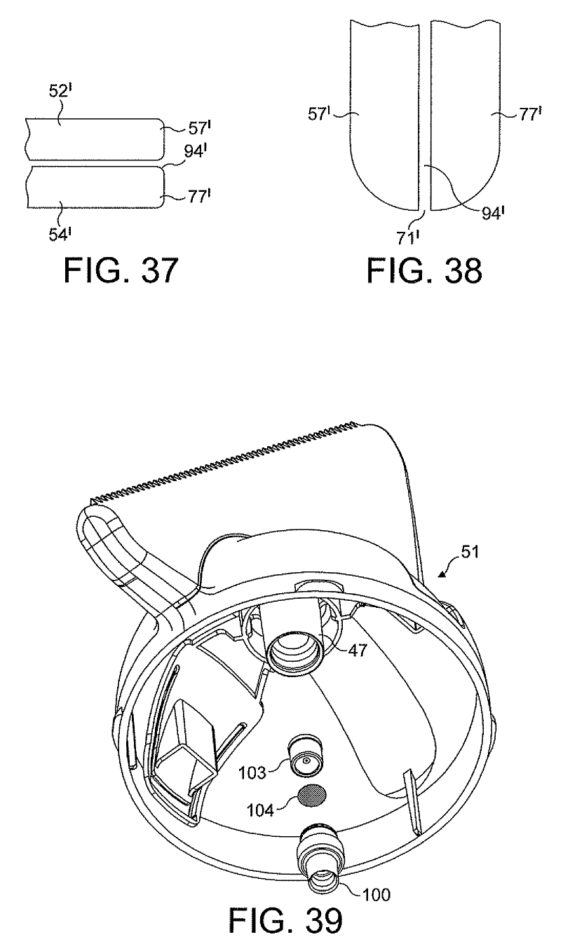

FIGS. 37 and 38 are side views showing an alternative nozzle for comparison purposes with the nozzle of FIG. 13,

FIG. 39 is a perspective view of the nozzle of FIG. 13,

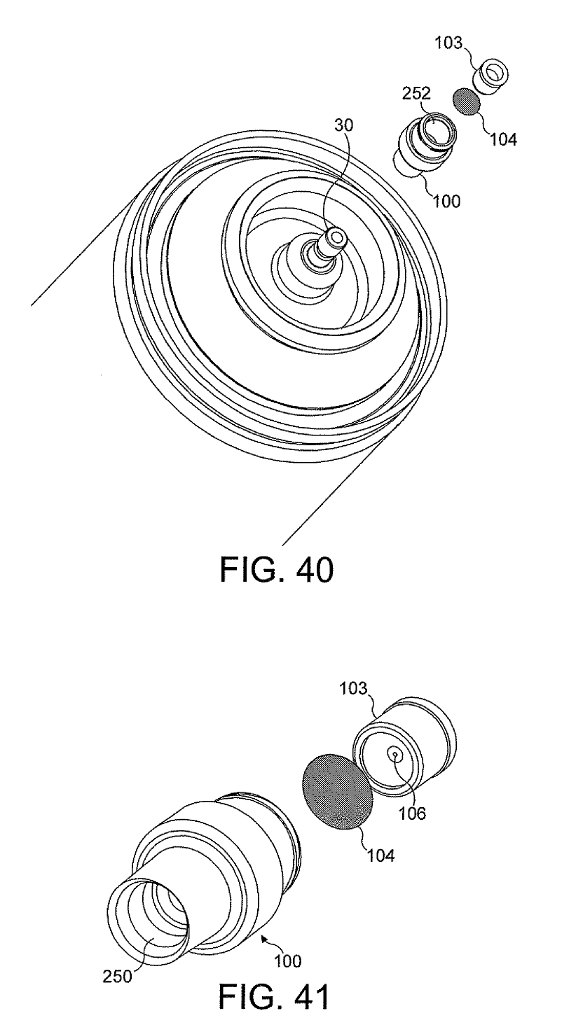

FIG. 40 is a perspective view of part of the paint canister of FIG. 3,

FIG. 41 is a perspective view of the auxiliary insert of the nozzle of FIG. 13,

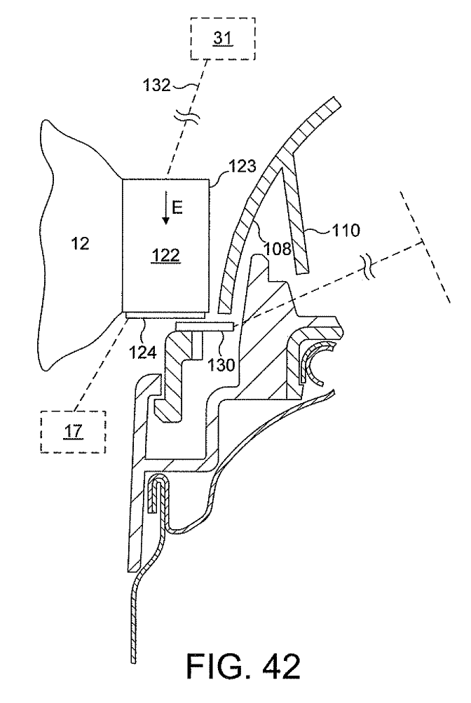

FIG. 42 is an enlarged sectional front view of the arrangement of FIG. 13 housed within the electrostatic paint spraying device of FIG. 1, and

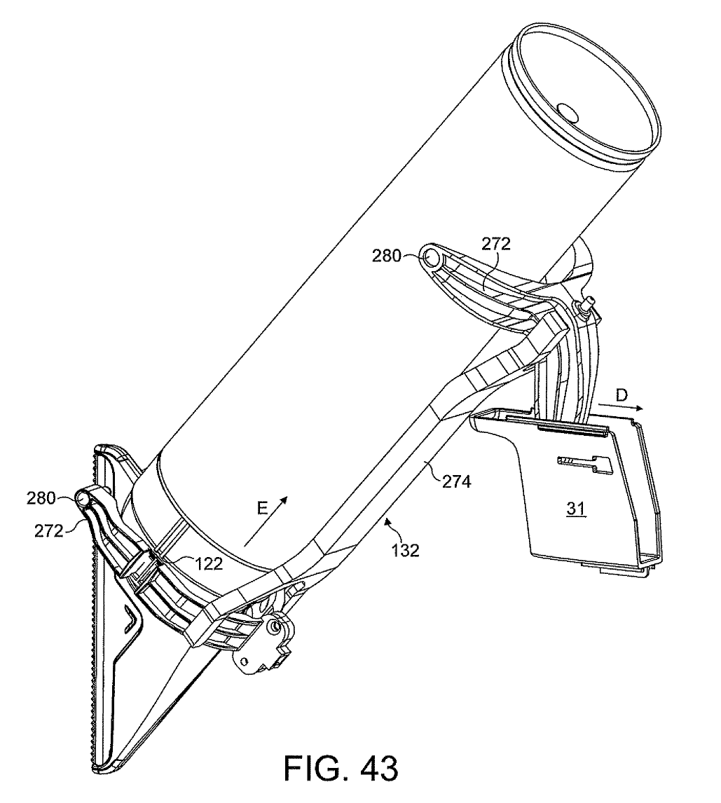

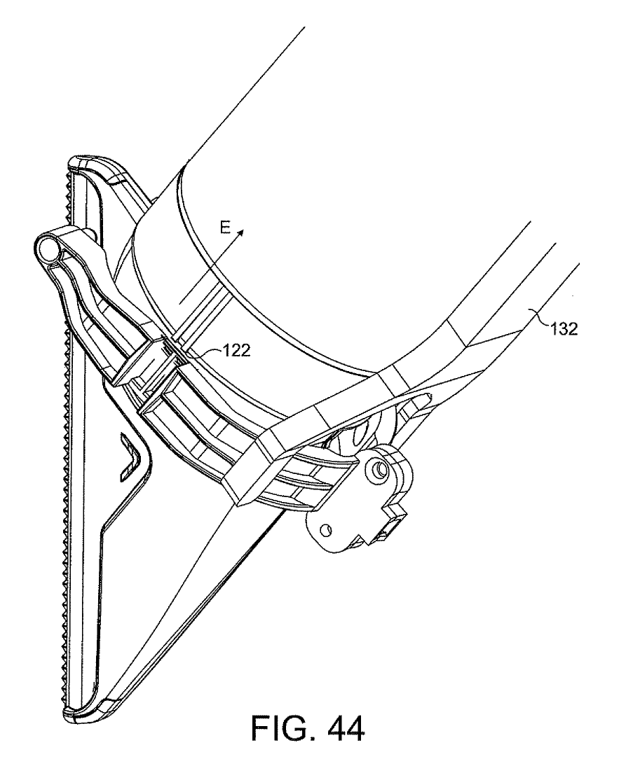

FIGS. 43 and 44 are perspective views of part of the electrostatic paint spraying device of FIG. 1.

With reference to FIGS. 1 to 3, there is shown an electrostatic paint spraying device 10 comprising a main body in the form of casing 12, an end surround 13, an inner shell 14, a cover 22, a paint canister 16 containing paint 27 which can be inserted into the casing 12, and a power supply 17.

The power supply 17 is a high voltage generator powered by four 1.5V primary cell batteries 205 which are provided in a plastic battery pack 19.

The battery pack is made from Ultramid A3XZG5 sbk23187 (supplied by BASF Plastics, BASF Aktiengesellschaft, 67056 Ludwigshafen, Germany) which is a flame proof to UL95 V-0.

With reference to FIGS. 2 to 2G, the battery pack 19 is mounted upon a battery cover 200 which snap-fits onto an enclosure housing 201 of the casing 12. The enclosure housing 201 includes a pair of front 202 and rear 204 projections.

The battery pack 19 comprises a main casing 206 and a closure 208.

The main casing 206 includes a battery compartment 210 for receiving the four primary cell batteries 205. The battery compartment 210 also includes two hollow cylindrical aluminium heat sinks 212 inside which the batteries 205 are housed. The purpose of the heat sinks 212 is to dissipate heat from the batteries 205 in the event of a short circuit. It can be seen from FIGS. 2B and 2C that the heat sinks 212 surround the batteries 205.

The closure 208 snap-fits onto the main casing 206 by engagement between projection 214 and recess 216 (FIG. 2D). The closure 208 includes an inner projection 230 which locates inside the main casing 206, the inner projection 230 extending inside the main casing 206 a distance X_{O} typically 20 mm, beyond a join 232 created between the closure 208 and the main casing 206.

With the batteries 205 inserted into the battery compartment 210, and the closure 208 secured via the snap-fit engagement, an electrical output 207 is made from the batteries 205 via contact plate 218 and circuit 220 (shown schematically in FIG. 2D). Circuit 220 includes internal current limiting circuitry arranged on a printed circuit board (PCB) 222 and a hollow cylindrical copper pin 224 which is electrical connected to the PCB 222 when the batteries compress spring 226 locates inside the copper pin 224.

The copper pin 224 locates inside a cylindrical projection 228 of the closure 206, creating an interference fit therebetween. The cylindrical projection 228 extends inside the battery compartment 210 so as to define a path length P_{O}, typically 6 mm, between the battery compartment 210 and the explosive atmosphere inherently created by the use of the electrostatic spray device 10 (FIG. 2F).

The provision of the inner projection 230 extending into the main casing 206 of the battery pack 19 creates a path sufficiently long such that in the event of a short circuit between the batteries 205 as a result of the explosive atmosphere entering the battery compartment 210, the explosive gases resulting will have sufficiently cooled before re-entering the explosive atmosphere.

Furthermore, the provision of the cylindrical projection 228 and the copper pin 224 creates a path sufficiently long enough to allow any escaping gases to cool before entering the explosive atmosphere.

It can also be seen from FIG. 2A that the battery pack 19 is a close fit between front projections 202 and rear projections 204 on the enclosure housing 201. Accordingly, the closure 208 will be retained on the main body 206 in the event of an explosion inside the battery pack 19. The projections 202,204 are dimensioned such that the close fit allows the closure 206 to move about 1 mm away from the main body before the closure abuts against the front projections 202.

The battery pack 19 is also designed as a pressure vessel so as to withstand internal pressures in the event of an explosion in the battery compartment 210 up to 10 Bar.

FIG. 2G shows details of the PCB, which limits the electrical output 207 from the batteries 205 to no more than 3 A.

The high voltage generator can generate up to 30 kV, with a potential divider (not shown) to generator a lower voltage of 5 kV for the field adjusting electrode.

A circuit diagram for the spray device 10 is shown in FIG. 2H.

The batteries 205 are electrically connected to the PCB 222 which creates an output 207 (limited to 3 A) to a power on switch 250. The power on switch 250 is connected to a vibrator 252 and an LED indicator 254 which give visible and audible notification that the spray device 10 is in operation. This is important due to the inherently quieter operation of electrostatic spraying when compared to other spraying methods such as aerosols.

The electrical output 207 is connected, via the switch 250 to a DC/DC converter 258, OSC generator 256, switching MOSFET 260, and a multi-stage high voltage doubler circuit 262. Charging and field adjusting electrodes (see below) are connected to the doubler circuit 262 which gives an output of 30 kV and 5 kV respectively.

The paint spraying device also includes an earth lead (not shown).

As an alternative to using primary cell batteries, rechargeable batteries or mains power supply is envisaged.

The casing 12 comprises two moulded side parts 12a,12b made from Acrylonitrile butadiene styrene (ABS).

Each of the two moulded side parts 12a, 12b includes a collar stop projection 220 located on and extending inwardly from an inside surface 222 (one of which is shown schematically in FIGS. 1 and 2) of the side parts 12a,12b.

The inner shell 14 comprises an upper portion 18 and a lower portion 20, both the upper and lower portions being separate mouldings, and is arranged such that when it locates inside the casing 12, and the paint canister is inserted, the paint canister is inclined at an angle of 45 degrees to the horizontal.

In an alternative embodiment, the inner shell can be arranged such that the paint canister is inclined at a different angle.

The upper portion 18 includes an upper partial nozzle surround 19 at one end, and the lower portion 20 includes a lower partial nozzle surround 21 at one end.

A field adjusting electrode comprising a first electrode 15a, and a second electrode 15b, each electrode having dimensions approximately 100 mm×20 mm×5 mm is secured on an outside surface 23 of the partial nozzle surrounds 19,21 (shown as broken lines in FIG. 2) such that they sit between the partial nozzle surrounds 19,21 and the end surround 13 once the spray device has been assembled.

The field adjusting electrodes 15a,15b are made from a conductive polymer, specifically a polypropylene resin containing carbon fibre (LNP*-STAT KON* Compound MC-1003 HS, supplied by General Electric Advanced Materials Plastics).

Referring to FIGS. 1 and 2, the paint spraying device 10 is assembled by firstly mating the upper portion 18 and the lower portion 20 of the inner shell 14.

The inner shell 14 is then positioned between the two side parts 12a,12b of the housing 12 before they are mated together. Mating of the two side parts 12a,12b creates a handle portion 11. The end surround 13 is secured to the assembled side parts 12a,12b such that it covers the field adjusting electrodes 15a,15b positioned on the outside surface 23 of the upper and lower partial nozzle surrounds 19,21.

After assembling the casing side parts 12a,12b, and inserting the inner shell 14, a rear open end 180 of the spraying device 10 is created. The rear open end 180 is at an opposite end to the end surround 13 and enables insertion of the paint canister 16 into the spraying device 10.

The rear open end 180 is closed by the cover 22.

With reference to FIGS. 4 to 11, the cover 22 includes an outer shell 136 and a concentric inner shell 138 which sits inside of, and is radially spaced from the outer shell 136.

The inner shell 138 has a top surface 137 which is fastened to an inside surface 139 of the outer shell 136 using a bolt (not shown). A spring 141 (the purpose of which is explained below) locates around the bolt between the top surface 137 and the inside surface 139 such that the inner shell 138 is spaced and biased away from the outer shell 136 in the downward direction when viewing FIGS. 4 and 5. The bolt includes a stop (not shown) which engages with the top surface to prevent the inner shell 138 becoming detached from the outer shell 136.

The inner shell 138 has a cylindrical side wall 145, and the outer shell has a cylindrical side wall 147. It can be seen from FIG. 5 that both the inner and outer shell side walls are tapered upwardly from the free lower ends, and that the inner shell side wall 145 extends below the outer shell side wall.

The outer shell 136 includes a projection 142 which extends downwards from the side wall 147. The projection 142 includes two protuberances 149 with a recess 151 located therebetween (FIG. 4).

With reference to FIGS. 1, 2 and 6 to 8, the casing 12 includes two identical switches 150 located on an upper end 152, and positioned in a recess 153 between the inner shell 14 and the casing 12. The recess 153 is arranged such that it has an overhang 155 (only shown in FIGS. 8 and 10) which prevent a user's finger from accessing the switches 150. A ridge (not shown) is also positioned between the two switches, cooperates with recess 151 to prevent a single implement pressing both switches at once.

When the cover 22 is positioned on the casing 14, the two protuberances 149 on projection 142 engage with both switches 150 to move both switches to a closed position. Unless both switches are in the closed position the power supply 17 is disabled. The provision of two switches eliminates powering of the paint spraying device by inserting an object into recess 153, instead requiring a special tool, in this case, the projection on the cover 22. Therefore unless the cover 22 is closed onto the casing 12, no power is provided to the electrodes.

It can also be see from FIG. 9 that the inner shell 138 of the cover 22 extends below the join 160 created when the cover is secured onto the casing. The join 160 is shown as a large gap for clarity but essentially the cover 22 and the casing 12 are in contact at the join 160. The inner shell 138 is arranged such that it extends beyond the join 160 a distance C that is sufficient to prevent electrostatic discharge from the paint canister 16 when housed in the paint spraying device, and hence avoid the risk of shock to the user. The distance C is typically in the region of 20-40 mm.

It can be seen from FIGS. 1 and 2 that, once the inner shell 14 and the casing 12 have been assembled, the upper 18 and lower 20 portions of the inner shell 14 form a join 202 that is angularly spaced by ninety degrees from a join 200 between the two side parts 12a,12b of the casing 12. By angularly spacing the joins 200,202 ninety degrees apart, the length of the discharge path from the paint canister 16 when housed in the inner shell 14 is maximised, and the risk of shock to the user minimised. Furthermore, the cover 22 closes off the rear open end 180 and extends below the join 160 sufficiently as described above such that the risk of discharge between the cover 22 and the casing 12 is minimised.

With reference to FIGS. 2, 3, and 12, the paint canister 16 comprises a main body in the form of an outer rigid container 24 onto which is fixed a nozzle 50. A collapsible inner bag 26 contains the paint 27 to be sprayed, and is located within the outer container 24, and is surrounded by propellant in the form of butane 28 which acts upon the inner bag to permit the paint 27 to flow from the inner bag via a release valve 30 positioned on a rigid top insert 116 of the paint canister (FIG. 12). The rigid top insert 116 is fixed relative to the outer container 24. The release valve 30 is biased by a spring 114 such that is always moves upwardly to a closed position where paint cannot flow. Spring 114 is weaker than the spring 141 positioned in the cover 22.

Other forms of paint supply are envisaged instead of the pressurised canister described above, for example, paint could be pumped to the nozzle, a compressor could be used, or gravity feed.

FIG. 12A shows the relationship between the vapour pressure of the butane relative to the temperature. Butane is chosen to generate a suitable paint flow rate (see below) which enables the paint to be atomised.

Five samples of a solvent based paint 27 were prepared based on different ratios of two different resins, a Polyurethane modified long oil alkyd resin solution, and an unmodified long oil alkyd resin solution.

Paint sample 1 is based on a polyurethane modified long oil alkyd resin comprising the concentrate detailed below in Table 1, which is then diluted in the ratio 92.3 parts concentrate to 7.7 parts low odour white spirit (raw material code L1207). Resin X101-561 has an oil length of 63.2%.

TABLE 1

| Material | % w/w |
|---|---|
| Polyurethane based long oil Alkyd Resin Solution (X101-561) | 86.84 |
| Bentone SD1 | 2.45 |
| Delaphos 2M | 2.353 |
| Lima Tinter Jet Black - 20% Pigment Loading | 2.098 |
| Durham Calcium 10/C9 | 2.353 |
| Cobalt Octoate 12% | 0.147 |
| Axilat 150/100 | 0.098 |
| Exkin 2/Methyl ethyl ketoxime | 0.294 |
| SPK D40 | 3.366 |

Paint sample 5 is based on an unmodified long oil alkyd resin comprising the concentrate detailed below in Table 2, which is then diluted in the ratio 92.3 parts concentrate to 7.7 parts low odour white spirit (raw material code L1207). Resin X102-548 has an oil length of 62.1%.

TABLE 2

| Material | % w/w |
|---|---|
| Long oil Alkyd Resin Solution (X102-548) | 84.651 |
| Bentone SD1 | 2.389 |
| Delaphos 2M | 2.294 |
| Lima Tinter Jet Black - 20% Pigment Loading | 2.045 |
| Durham Calcium 10/C9 | 2.389 |
| Cobalt Octoate 12% | 0.143 |
| Axilat 150/100 | 0.0956 |
| Exkin 2/Methyl ethyl ketoxime | 0.287 |
| SPK D40 | 5.801 |

Paint sample 2 is a mixture of the modified and unmodified resins, comprising 75% of the modified resin and 25% of the unmodified resin.

Paint sample 3 is a mixture of the modified and unmodified resins, comprising 50% of the modified resin and 50% of the unmodified resin.

Paint sample 4 is a mixture of the modified and unmodified resins, comprising 25% of the modified resin and 75% of the unmodified resin.

Paint samples 2 to 4 were obtained by mixing the desired ratio of both resins as stated above, with the concentrate then diluted in the ratio 92.3 parts concentrate to 7.7 parts low odour white spirit (raw material code L1207).

A further sample, paint sample 6 is based on a polyurethane modified long oil alkyd resin comprising the concentrate detailed below in Table 3, which is then diluted in the ratio 92.3 parts concentrate to 7.7 parts low odour white spirit (raw material code L1207). Paint sample 6 includes titanium dioxide (TR92).

TABLE 3

| Material | % w/w |
|---|---|
| Polyurethane based long oil Alkyd Resin Solution (X101-561) | 73.362 |
| Bentone SD1 | 0.98 |
| Delaphos 2M | 2.353 |
| Tioxide TR92 | 17.647 |
| Lima Tinter Violet | 0.0068 |
| Durham Calcium 10/C9 | 2.353 |
| Cobalt Octoate 12% | 0.147 |
| Axilat 150/100 | 0.098 |
| Exkin 2/Methyl ethyl ketoxime | 0.294 |
| SPK D40 | 2.758 |

The viscosity, and electrical properties for each paint sample was measured according to the methods described below.

Each sample was sprayed with the electrostatic spray device of the present invention.

The spray results, and the properties of each sample are given below in Table 4.

The above paint formulation is an example only, and it will be appreciated that those features of the present invention that are not dependant on the type of paint are not limited to being used with such a paint formulation.

### Measurement of Viscosity

The viscosity measured was an ICI Cone & Plate viscosity at 25° C. and 10000 s⁻¹, this being measured on a 0-10 Poise Cone & Plate Viscometer (R.E.L. Standard Model) according to BS3900 Part A7 2000 (and ISO 2884-1 1999.

### Measurement of Dielectric Constant and Conductance

A plate capacitor 300 comprising two plates 210 and 220 was constructed as shown in FIGS. 3A (with no paint between the two plates) and 3B (with paint between the plates).

The amount of paint required to fill the gap between the plates of the capacitor was 3 mL.

For each sample (samples 1 to 5) of paint, the plates were connected to the circuit of FIG. 3C with a Schlumberger 1260 gain phase analyser 400 being used to measure V1 and V2.

The applied voltage V was 0.1V, and the frequency f was set at 1000 Hz. The gain resistor R had a resistance of 1000 Ohms.

Based on the readings for V1 and V2, the admittance (Y) of the capacitor was calculated according to the equation:

−V1/(R×V2)=i/N=Y=G+jB

Therefore, the real part of the signal gives the Conductance (G) multiplied by 1000 (the value of the gain resistor). The imaginary part of the signal gives the Susceptance (B) multiplied by 1000 (the value of the gain resistor).

The capacitance was then calculated according to the formula:

Susceptance (B)=(2πf)/Capacitance

The dielectric constant was then calculated according to the formula:

Capacitance=(Dielectric Constant×Permittivity of free space×Area A of one plate)/separation of plates d

where the surface area of one of the plates was 6.36×10⁻³ m², the separation of the plates was 75×10⁻⁶ m, and the permittivity of free space is 8.854×10⁻¹² C²/N.m².

The resistance was then calculated as the reciprocal of the capacitance. The resistivity is calculated based on the equation:

resistivity=(resistance×Area A of one plate)/separation of plates d

The conductivity is the reciprocal of the resistivity.

The calculation of the dielectric constant for free space (air) was calculated and checked against the theoretical value to confirm the experimental set up was correct.

All measurements were taken at 24(° C.+/−1° C.).

With reference to FIGS. 13 to 38, the nozzle 50 includes a spray head 51 and a collar 53. The collar 53 releasably snap-fits onto an upper rim 33 of the outer rigid container 24 (FIG. 14).

The spray head 51 releasably snap-fits onto the collar 53 via engagement of projection 41 on the spray head 51 and projection 43 on the collar 53.

The spray head 51 has a first clam shell 52 and a second clam shell 54. Each clam shell 52,54, and the collar 53 is produced by injection moulding from ABS.

The first clam shell 52 has triangular shaped plate-like portion 58, and a hemispherical portion 56. The hemispherical portion 56 includes a through hole 43 (FIG. 20).

A hollow cylindrical tube 47 (FIGS. 14 and 20) extends radially inwardly from an inside surface 39 of the hemispherical portion 56. The hemispherical portion further includes a through slot 49.

The triangular shaped portion 58 of the first clam shell 54 includes a first partial chamber 53 which is enclosed by a first rear upstanding wall 55, and two end upstanding walls 57. The distance between the outside surfaces of each end wall is X₁ (FIG. 20). Either side of the first rear upstanding wall 55 is a ledge 81 positioned vertically below the upstanding wall 55 (best seen in FIG. 26).

A charging electrode 190 is positioned in the first partial chamber 53. The charging electrode 190 is made from the same conductive polymer as the field adjusting electrode.

The first rear upstanding wall 55 includes a rectangular recess 45 to enable passage of an electrical connection, in this embodiment, a metallic strip 192 between the charging electrode 190 and ultimately the power supply 17 (FIG. 20).

The triangular shaped portion 58 of the first clam shell 52 includes an elongated region 59 having a flat surface 61.

The second clam shell 54 has a triangular shaped plate-like portion 60, virtually identical in outline plan profile to the plate-like portion 58 of the first clam shell 52, and a semi-circular recess 62 which has the same diameter as the hemispherical portion 56, and allows the hemispherical portion 56 to locate therein.

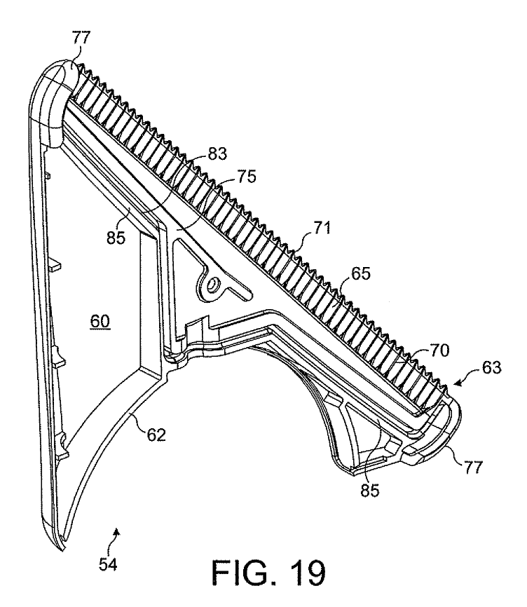

The triangular shaped portion 60 of the second clam shell 54 includes a second partial chamber 73 which is enclosed by a second rear upstanding wall 75, and two end upstanding walls 77 having end surfaces 96. The distance between the inside surfaces of each end wall 77 is X₂ (FIG. 21) which is slightly larger than X₁. A third upstanding wall 85 which is parallel to the second rear upstanding wall 75 creates a channel 83 therebetween (best seen in FIGS. 19,21, and 25).

The triangular shaped portion 60 of the second clam shell 54 includes an elongated region 63 having a flat surface 65. The flat surface 65 of the second clam shell 54 includes a saw-toothed edge profile 71 when viewed from above (best seen in FIG. 21). The flat surface 65 further includes fifty equally spaced and parallel open channels 70 which extend from each tip 93 (FIG. 32) into the second partial chamber 73. The channels 70 are arranged linearly along the length X₂ of the nozzle.

With reference to FIGS. 32A and 32B each channel has a depth C_{D} of 0.4 mm, a width C_{W} of 0.25 mm, and a length C_{L} of 3 mm. The channel centre lines are spaced apart by a distance C_{S} of 2 mm along the length X₂, which is 100 mm, of the nozzle.

The number of channels are chosen such that at the extremes of flow rate (see below), the paint is atomised. It is a matter of experimentation to balance the number of channels to successfully form ligaments of paint from each channel according to the paint flow rate used.

For a fixed number of channels, if the flow rate is too high, then paint does not flow through all of the channels, which results in an uneven flow, and reduced atomisation from those channels which the paint does flow through due to the increased flow rate. Conversely, if the flow rate is too low, then new ligaments are not set up between each channel.

The first and second clam shells 52,54 are assembled by bringing the two surfaces shown uppermost in FIGS. 20 and 21 together such that the semi-circular recess 52 locates around the hemispherical portion 56, and the rear upstanding wall 55 of the first clam shell 52 (FIG. 26) locates inside channel 83 of the second clam shell 52 (FIG. 25) to obtain the assembled spray head 51 of FIG. 27 (also shown in FIGS. 23 and 24).

The rear upstanding wall 55 and the channel 83, and abutting surfaces of the end walls of each of the clam shells are joined by ultrasonic welding.

Once assembled, the two partial chambers 53,73 combine to create a chamber 92.

Each of the open channels 70 are closed by the flat surface 61 as shown in FIG. 33. This is advantageous since it is easier to mate the open channels against a flat surface than attempting to mate two half channels on respective clam shells where alignment and tolerances can cause problems.

It can be seen that the nozzle 50 comprises fifty equally spaced and parallel channels which are arranged linearly on the elongated region. The elongated region is 100 mm in length.

FIGS. 34 (prior to assembly) and 25 (assembled) show that the end walls 57 of the first clam shell 52 fit inwardly of the end walls 77 of the second clam shell 54 due to X₂ being slightly greater than X₁.

FIGS. 28 (prior to assembly) and 29 (assembled) show the overlapping of end walls 57,77, and the join 94 created between the two end walls when looking in the direction of Arrow B (FIG. 35), i.e. view of the end surface.

FIGS. 30 (prior to assembly) and 31 (assembled) shows how the end wall 57 of the first clam shell 52 sits inwardly of end wall 77 of the second clam shell 54 and also the join 94 between the first and second clam shell walls 57,77 when looking in the direction of arrow A (FIG. 35), i.e. a view of the front surface.

A view of the upper surface of join 94 can also be seen in FIGS. 34 and 35.

From FIG. 29 it can be seen that the join 94 between the first and second clam shells is a distance Y from the saw toothed edge 71. Joins typically disturb the electrostatic field and cause discharge. By providing the join at this distance from the end surface, electrostatic discharge from the end surface 96 of the second clam shell 54 is prevented when paint is being sprayed from channels 70 since

It is important to understand that electrostatic discharge is only significant in areas that are non-wetted, i.e. areas where there is no paint flow. Therefore the end surface 96 of the second clam shell 54 is a particularly sensitive area, and the reason why the two end walls 57,77 overlap such that the join 94 is a distance Y, approximately 13 mm, from the saw toothed edge 71 from where paint is propelled towards the target surface.

FIGS. 37 and 38 show an end wall design where the two end walls 57′,77′ do not overlap but abut against each other such that join 94′ runs between the two end walls on the end surface immediately adjacent the saw toothed edge 71′ from where paint is propelled. This design demonstrates the problem the present invention overcomes, i.e. avoiding a join on the end surface so as to prevent electrostatic discharge. The present invention achieves this by overlapping the end walls such that one of the clam shells sits inwardly from the other.

Once assembled, a paint path 90 in the spray head 51 is defined by the hollow cylindrical tube 47, the through hole 43, the chamber 90, and the channels 70 as shown in FIG. 36.

With reference to FIGS. 14, and 39 to 41, an auxiliary insert 100 having a filter 104 and flow rate control orifice insert 106 downstream of the filter 104 is provided between the release valve 30 of the paint canister 16 and the hollow cylindrical tube 47 of the spray head 51 (FIG. 14).

The auxiliary insert 100 has a first open cylindrical end 250 which releasably fits onto the nozzle release valve 30 of the paint canister 16, and a second open cylindrical end 252 which receives the flow rate control orifice insert 103 and the filter 104, and also releasably fits onto tube 47 of the spray head 51.

The control orifice insert 10 includes an internal cylindrical through hole 106 of diameter 0.22 mm, although a range of approximately 0.11 mm to 0.5 mm can be used.

The purpose of the control orifice 106 is to reduce the flow rate from the pre-pressurised paint canister to an acceptable level to enable electrostatic spraying. Typically the flow rate is in the order of 20 ml/min, with a working range of between 12 ml/s, below which the flow rate is simply too slow for a satisfactory painting time, and 30 ml/s, above which the paint finish is unsatisfactory. The diameter of the control orifice is therefore less than the diameter of the release valve on the paint canister so that the control orifice in the nozzle provides all the flow restriction to reduce the flow rate.

The diameter of the orifice is chosen to match the paint flow rate required to the vapour pressure of the propellant in the canister. It is therefore advantageous to use a canister with the lowest vapour pressure available in order to maximize the diameter of the orifice and therefore maximise the tolerance of the design. For this purpose, the propellant Butane was used.

The diameter of the control orifice is selected to obtain the desired flow rate from the spray head for satisfactory electrostatic spraying, and is dependant on the flow rate obtained from the pre-pressurised paint canister. Accordingly, selection of the orifice diameter is a simple matter of experimentation to achieve the desired flow rate.

The through hole 106 is two dimensional or perfectly flat, and therefore the pressure drop as paint flows through it is substantially independent of the paint viscosity which is advantageous since the viscosity changes with the temperature.

The flow rate control orifice insert 103 can be produced by injection moulding, spark erosion, laser drilling, mechanical drilling or punching.

The filter 104 prevents paint particles of greater than 125 μm passing through.

Since the flow rate has been reduced by the control orifice to enable satisfactory electrostatic spraying, the filter 104 is important as it removes any large paint particles that could otherwise block the paint path. Ordinarily, if a higher flow rate was used, large paint particles are not such a concern, and therefore a filter is not essential. Clearly this depends on the particle distribution of the paint, but in general, a lower flow rate creates a greater likelihood of paint particles blocking the paint path.

By providing the control office and filter as a releasably attachable insert 100 it is possible to replace it as necessary, for example if a different sized filter or control orifice is required depending on the type of paint being used, and/or the type of pre-pressurised canister being used.

With reference to FIGS. 13 to 15, the hemispherical portion 56 of the spray head 51 includes a resilient tab 108 formed in its hemispherical wall 109. The resilient tab 108 includes a latch projection 110 which extends downwardly from the hemispherical wall 109.

The collar 53 includes a locking projection 112 which is arranged relative to the spray head 51 such that the latch projection 110 cannot move downwards, i.e. the latch projection 110 abuts against the locking projection 112, such that the spray head is in a locked position. This prevents relative movement between the spray head 51 and the collar 53 when the resilient tab 108 is in the position shown in FIGS. 14 and 15.

When the paint canister 16 is inserted into the casing 12, a release arm 122 (see below), which is fixed onto the inside of the casing, but moveable under the action of trigger 31 (see below), engages with the resilient tab 108 on the spray head 51 to move it to the position 108′,110′ indicated by the broken lines in FIG. 15, i.e., an unlocked position, where is can be seen that the latch projection 110′ can move downwardly without abutting the locking projection on the collar 53, and therefore the spray head 51 can move vertically downwardly relative to the collar 53.

With reference to FIGS. 14, 15, and 36, it can be seen that when the spray head 51 is free to move vertically downwardly relative to collar 53 (when the resilient tab is in the position indicated by the broken lines of FIG. 15), the paint release valve 30 can move downwardly (under the action of trigger 31) relative to the rigid top insert 116 causing the release valve 30 to open and allow paint to flow through the auxiliary subassembly 100, hollow cylindrical tube 47, through hole 43, chamber 92, and channels 70 before being propelled towards the target surface.

Thus it will be understood that it is selectively possible to lock the spray head 51 to prevent paint flow until the paint canister 16 is located inside the casing 12, and the trigger 31 is activated. This prevents paint flow from the canister when outside of the canister.

The charging electrode 190 is also in electrical contact, via metallic strip 192 (FIG. 20), with a metal tab 130 positioned inside the hemispherical portion 56 and extending radially outwardly such that it extends beyond the resilient tab 108. The significance of this arrangement will be explained below.

With reference to FIG. 42, the paint spraying device 10 includes a release arm 122 which is positioned on the inside of the casing 12 such that when the paint canister 16 is inserted into the casing 12, a side surface 123 of the release arm 122 engages with the resilient tab 108 of the spray head 51 to move the resilient tab 108 inwardly such that the spray head 51 is in the unlocked position.

The release arm 122 includes a metal contact strip 124 located on its lower surface, the metal strip being connected to the power supply 17.

Referring back to FIGS. 1 and 2, the paint spraying device 10 includes a trigger 31 which is connected by a linkage 132 (shown schematically as a broken line in FIGS. 1 and 42) to the release arm 122.

FIGS. 43 and 44 show the linkage 132 in more detail. The linkage 132 comprises a first arm 270 which is connected to the trigger 31, and a second arm 272 which includes the release arm 122. The first and second arms are connected by a link 274. The ends 280 of the first and second arms locate on lugs (not shown) on the casing 12. Operation of the trigger 31 in the direction D causes rotation of the first arm 270 about the casing lug, which in turn causes the second arm 272 to rotate about the casing lug as it is connected by link 274. Rotation of the second arm 272 causes the release arm 122 to move in the direction E.

With reference to FIG. 42, it can be seen that the linkage 132, when the trigger 31 is operated to the on position (direction D), causes the release arm 122 to move downwards (direction E) such that the metal contract strip 124 acts upon the metal tab 130, and hence upon upper surface 120, to move the spray head 51 downwards to open the paint release valve 30 on the paint canister 16.

Thus it can be seen the trigger 31 perform two functions. Firstly it creates an electrical contact between the charging electrode and the power supply, and secondly it opens the paint release valve to enable paint flow.

It will also be appreciated that the release arm 122 itself performs two functions. Firstly the release arm abuts against the resilient tab 108 to unlock the spray head when the canister is inserted into the housing. Secondly, the release arm provides paint flow and electrical contact under the action of trigger 31.

Whilst only half of the nozzle is shown in FIG. 42, it will be appreciated that the other half is identical except for the lack of provision of a metal tab 130 on the radially opposite resilient tab, there clearly being need for only one electrical contact between the power supply and the charging electrode. Similarly, the radially opposite release arm does not include a metal contact strip, instead its lower surface directly engages with the upper surface 120 of the spray head.

In practice the electrical contact is made before the paint release valve has sufficiently opened to provide paint in the region of the charging electrode, and therefore paint arriving at the charging electrode will be charged and propelled towards the target. Furthermore, it takes time for the pressure to be build up before the paint starts to flow, and therefore by the time the paint arrives at the nozzle, the electrodes will be charged.

When the trigger 31 is released, similarly the paint release valve 30 will close before the electrical contact is broken, and hence paint remaining in the region of the nozzle will still be charged and propelled towards the target. Furthermore, the paint canister acts like a capacitor in the sense that it will take a short time to lose its charge, and therefore charge any paint in the nozzle after the trigger as been released. Thus the possibility of paint dripping from the nozzle due to it being uncharged is reduced.

The paint canister 16 is loaded into the casing 12 of the spray device 10 as follows:

With reference to FIGS. 2 and 3, the user holds the paint canister 16 in the region of end 170 and inserts the nozzle 50 through the rear opening 180, and inside the inner shell 14 until the release arm 122 engages with the resilient tab 108 of the spray head 51, thereby giving a positive indication that the canister has been correctly inserted (FIG. 42).

The collar 53 of the paint canister 16 will also abut against the collar stop 220 when it is inserted. To make up for any dimensional tolerances, if the collar 53 and collar stop 22 do not abut then the provision of spring 141 in the cover 22 forces the paint canister 16 towards the collar stop 220 until they collar 53 and collar stop 220 engage. The spring 141 thus ensures that the paint canister 16 has been against the collar stop, and that as a consequence, the release arm 122 engages with the resilient tab 108 of the spray head 51 to unlock the spray head 51.

It will be appreciated that the provision of the nozzle 50 at one end, and the fact that the inner shell has the rear opening 180 enables the paint canister to be loaded into the spraying device without having to manipulate the nozzle, thereby avoiding coming into contact with electrical contacts, and any paint that may have dripped from the nozzle.

After the paint canister 16 is located in the casing 12, the cover 22 is positioned on the casing such that outer shell 136 of the cover 22 abuts against the casing, and the inner shell 138 of the cover 22 surrounds the end 170 of the paint canister 16.

It can be seen from FIGS. 1 and 2 that after the paint canister 16 is inserted into the casing 12, the paint canister 16 is enclosed by the inner shell 14 and the cover 22, with the discharge paths between joins maximised as discussed above. The user is therefore protected from electrostatic discharge from the paint canister 16.

In an alternative embodiment, the inner shell can be adapted such that it is not pre-assembled into the housing, but pre-assembled onto the paint canister such that the paint canister and inner shall are inserted directly into the housing. Furthermore, the inner shell need not be made from two portions, but can be of unitary construction, whether it is pre-assembled onto the paint canister or pre-assembled into the housing, and as such contains no joins to allow electrostatic discharge.

After the paint canister has been inserted into the casing, the release arm 122 positioned on the casing engages with the resilient tab 108 of the spray head 51 to move the resilient tab 108 inwardly such that the spray head 51 is in the unlocked position.

Once the cover 22 has been positioned on the casing 12 the interaction between the two protuberances 149 and switches 150 enables the power supply. Until the cover is on, no power can be supplied to the electrodes.

Once the paint canister 16 has been inserted into the inner shell 14, the upper and lower partial nozzle surrounds 19,21 and hence the field adjusting electrodes 15a,15b sitting thereon, are positioned radially outward, and forward of the plurality of channels 70 of the nozzle 50.

The electrostatic paint spraying device is operated as follows:

A user (not shown) grasps the spraying device 10 by the handle portion 11 and positions it in front of the target surface (not shown).

The user connects the earth lead to the same ground as the target surface such that electrical connection between the target and the sprayer power supply is completed and charge can flow to maintain a zero potential difference between the sprayer and the target.

The user can also connect the earth lead to the target being sprayed. This has the same effect as connecting to the same ground as described above.

The user pulls the trigger 31, which charges the field adjusting electrode to 5 kV, and the charging electrode to 30 kV, and then opens the release valve 30 on the paint canister 16. Since the spring 114 on the paint canister release valve 30 is weaker than the spring 141 on the cover 22, the action of the trigger will compress spring 114. Paint 27 then flows from the inner bag 26 under the force of the propellant, before arriving at the nozzle where it is charged by the charging electrode 190.

The field adjusting electrodes 15a,15b are arranged on the inner shell 14 such that when the paint canister 16 is housed in the inner shell, the field adjusting electrodes sit in front of the charging electrode 190, and therefore a potential difference is established between the charging electrode 190 and the field adjusting electrodes 15a,15b. The electrostatic field in the vicinity of the nozzle is sufficient to cause the paint to be atomised and accelerated towards the field adjusting electrodes, but without colliding with the field adjusting electrodes. After the paint has passed the field adjusting electrode the atomised paint enters a region between the paint spray device and the target surface. The electrostatic field in this region as a result of the field adjusting electrode causes the paint to be propelled towards the target where it forms a coating thereon, the electrostatic nature of the paint flow causing the coating to wrap-around the back of the target if the target has a back surface, for example, an iron railing.

The field adjusting electrode defines the electrostatic field in the vicinity of the nozzle, and renders the field relatively immune to the distance from the target surface. The field adjusting electrode is therefore set at a lower potential than the charging electrode, but greater than zero. 5 kV is sufficient to attract paint towards the target object but still obtain a field strength high enough to atomise the paint.

Using the appropriate paint and electrostatic spray device as described above, it is possible to supply the paint to the nozzle such that it is atomised and propelled towards the target. Where the target has a front and a rear surface that requires painting, for example, if the target is a set of iron railings, the atomised paint, by virtue of it being charged is also attracted to the rear surface in what is referred to as a ‘wrap around’ effect.

The properties of each paint sample, and the spray performance is given below in Table 4.

TABLE 4

| | | Conductance | | Dielectric | | | |
|---|---|---|---|---|---|---|---|
| | Viscosity | (G) Siemens | Resistance | Constant | Resistivity | Conductivity | |
| Sample | (Poise) | (1/Ohms) × 10⁻⁶ | (R) Ohms × 10⁴ | Eᵣ | Ωm × 10⁶ | nSm⁻¹ | Sprayability |
| Sample 1 | 2.4 | 19.66 | 5.09 | 3.890 | 4.31 | 232 | Best |
| | | | | | | | performance |
| Sample 2 | 2.5 | 18.9 | 5.29 | 3.707 | 4.49 | 223 | Sprayable |
| | | | | | | | Splattery |
| Sample 3 | 2.5 | 10.6 | 9.43 | 3.591 | 8.00 | 125 | spray |
| | | | | | | | Splattery |
| Sample 4 | 2.6 | 7.88 | 1.27 | 3.467 | 10.8 | 92.9 | spray |
| | | | | | | | Not |
| Sample 5 | 2.5 | 5.17 | 1.93 | 3.391 | 16.4 | 61.0 | sprayable |
| Sample 6 | 2.4 | 35.87 | 2.79 | 4.664 | 2.36 | 423 | Slight |
| | | | | | | | Overspray |

The applicant has found that a conductivity range of between 75 and 450 nano-Siemens per metre (nSm⁻¹) gives acceptable spray performance, with a superior performance between 90 and 420 nano-Siemens per metre (nSm⁻¹).

Below this acceptable range there is insufficient charge density in the paint for atomisation, with the result that the paint is not propelled towards the target, and is classed as not sprayable.

Above this range there is excessive charge density in the fluid giving problems of overspray and transfer of paint to surfaces other than the intended target.

Between the two extremes, the sprayability increases from not sprayable, to sprayable with slight splattering, i.e. dripping of paint due to insufficient atomisation, before the best spray performance is achieved where all the paint is atomised with no overspray.

The applicant has discovered that paints that derive a higher charge per unit mass in the spray device experience greater atomisation. The charge per unit mass is mainly determined by the conductivity of the paint but there is an increase in current with flow rate indicating some partial saturation of the charge capacitance during contact of the paint with the electrode. The charge per unit mass will therefore increase with both the conductivity and the ratio of dielectric constant to conductivity.

It will be understood that different resins can be sprayed providing they have similar electrical properties as defined above.

The applicant has also found that a viscosity range between 2 and 3 Poise enables sufficient atomisation to allow the paint to be sprayed, whilst still forming a satisfactory coating in terms of avoidance of sag.

It can be seen from FIGS. 14 and 36 that a paint path is created between the inner bag 26 of the paint canister and the plurality of channels 70, and that no paint comes into contact with other parts of the spraying device when paint is being sprayed. This is advantageous since no cleaning is required when the paint job is finished or when replacing canisters, for example, for a different colour or type of paint.

It can be seen from FIG. 1C that the paint canister 16 is inclined at angle of approximately 45 degrees relative to the horizontal. This inclination is relative to when paint is being propelled from the nozzle 50 substantially horizontal.

Inclining the paint canister 16 enables a more compact spraying device compared to known spraying devices where the paint canister is often in-line with, or perpendicular to the paint flow once it has been propelled from the nozzle. This means that longer, and hence greater capacity canisters can be used whilst still maintaining a compact spraying device. Furthermore, the weight distribution is also improved with the canister positioned at an angle above the handle portion 11.

It can be seen from FIG. 1C that the lowest point of the nozzle is positioned vertically below the lowest point of the handle portion 11. This enables target surfaces to be sprayed close to ground level without the handle portion 11 fouling against the ground. This is particularly advantageous because to obtain even paint coverage on the target surface it is better to apply paint horizontally rather than at an angle.

It will be appreciated that the example above describes an electrostatic paint spraying with specific components such as the nozzle and the paint canister. However, it should be understood the functionality of the paint spraying device, the nozzle, and the paint canister, as well as other features described are afforded independent protection, and are not to be limited to use with the components with which they are exemplified.

1. An electrostatic paint spraying device comprising a paint canister fluidly connected to a nozzle of the paint spraying device, in which the nozzle comprises a spray head having a plurality of channels from which paint is propelled.

2. An electrostatic paint spraying device according to claim 1 in which the channels are substantially parallel to each other.

3. An electrostatic paint spraying device according to claim 1 in which the spray head comprises an elongated portion, the channels being linearly arranged on the elongated portion.

4. An electrostatic paint spraying device according to claim 1 in which the paint canister is releasably attachable to the device.

5. An electrostatic paint spraying device according to claim 1 in which the paint canister is pre-pressurised.

6. An electrostatic paint spraying device according to claim 5 in which the pre-pressurised paint canister comprises an outer container and a collapsible inner bag located within the outer container, in which the outer container contains a propellant which acts upon the inner bag to permit paint to flow from the inner bag towards the nozzle via a release valve positioned on the inner bag.

7. An electrostatic paint spraying device according to claim 1 in which the nozzle is integrated with the paint canister.

8. An electrostatic paint spraying device according to claim 1 in which the nozzle includes an integrated charging electrode.

9. An electrostatic paint spraying device according to claim 1, the paint canister being pre-pressurised, the paint canister including a release valve having a first diameter to enable paint to be supplied to the nozzle, the release valve being fluidly connected to the nozzle via a conduit, in which the conduit includes an auxiliary orifice having a second diameter which is smaller than the first diameter so as to reduce the flow rate from the paint canister.

10. An electrostatic paint spraying device according to claim 9 in which the nozzle includes the auxiliary orifice.

11. (canceled)

12. An electrostatic paint spraying device according to claim 9 including an insert that is releasably attachable to the nozzle and the paint canister, in which the insert includes the auxiliary orifice.

13. An electrostatic paint spraying device according to claim 9 in which the conduit further includes a filter, the filter positioned upstream of the auxiliary orifice.

14. (canceled)

15. A pre-pressurised paint canister for use in an electrostatic paint spraying device.

16. A pre-pressurised paint canister according to claim 15 in which the pre-pressurised paint canister comprises an outer container and a collapsible inner bag located within the outer container, in which the outer container contains a propellant which acts upon the inner bag to permit paint to flow from the inner bag towards a nozzle of an associated electrostatic spray spraying device via a release valve positioned on the inner bag.

17-24. (canceled)

25. A nozzle for an electrostatic paint spray device, the nozzle comprising a first moulded clam shell and a second moulded clam shell, the first and second moulded clam shells being arranged such that once assembled together, a chamber and a plurality of channels are formed between the clam shells, the chamber and plurality of channels defining part of a paint path from a paint supply.

26. A nozzle according to claim 25 in which the nozzle further includes a conduit fluidly connecting the chamber to the paint supply such that the paint path is defined by the conduit, chamber, and the plurality of channels.

27-31. (canceled)

32. A nozzle according to claim 25, the nozzle including a spray head and a collar, in which the spray head is moveable relative to the collar, and movement of the spray head relative to the collar causes the spray head to engage with an outlet of the paint canister such that paint flows from the paint canister and into the chamber.

33. A nozzle according to claim 25 in which the first clam shell has a first upstanding end wall at each end of the chamber, the second clam shell has a second upstanding end wall at each end of the chamber, the first upstanding end walls sitting inwardly of the second upstanding end walls such that there is no join between the two upstanding walls on an outside end surface of the second upstanding end walls.

34. A nozzle according to claim 25 in which the first clam shell has a first upstanding end wall at each end of the chamber, the second clam shell has a second upstanding end wall at each end of the chamber, the first upstanding end walls sitting inwardly of the second upstanding end walls such that a join between the two upstanding walls on an outside end surface of the second upstanding end walls is spaced at a distance sufficient from the plurality of channels to prevent electrostatic discharge in the vicinity of the plurality of channels.

35. A nozzle according to claim 25 in which the first and second clam shells are injection moulded.

36. A nozzle according to claim 25 in which a charging electrode is located inside the chamber.

37. A nozzle according to claim 25 in which the plurality of channels are formed by a plurality of open channels on one of the clam shells, and a flat surface on the other clam shell such that once assembled together the plurality of channels are closed.

38. A nozzle according to claim 25 in which abutting surfaces of the first and second clam shell surrounding the chamber are joined by ultrasonic welding.

39-44. (canceled)

45. An electrostatic paint spraying device comprising a casing and a paint canister, the paint canister including a release valve to control release of paint from the canister, in which the paint canister includes a locking feature which cooperates with a corresponding unlocking feature on the paint spraying device such that the release valve cannot release paint until the locking and unlocking features engage.

46. An electrostatic paint spraying device according to claim 45 in which the cooperation between the locking feature on the paint canister and unlocking features on the spraying device is by engagement.

47. An electrostatic paint spraying device according to claim 45 in which the locking feature is provided on a nozzle of the paint canister.

48. An electrostatic paint spraying device according to claim 47 in which the nozzle includes a collar fixed to the paint canister, and a spray head that is moveable relative to the collar, movement of the spray head relative to the collar causing the release valve on the canister to open to enable paint flow, the relative movement being prevented until the spray head engages with a release arm positioned on the casing.

49. An electrostatic spraying device according to claim 48 in which the relative movement between the spray head and collar to enable paint flow is actuated by a trigger connected to the release arm.

50. An electrostatic paint spraying device according to claim 49, the release arm being electrically connected to the power supply, in which actuation of the trigger enables paint flow and provides power to charging and field adjusting electrodes.

51-94. (canceled)
